(19) United States
(12) Patent Application Publication
(10) Pub. No.: US 2011/0294496 A1
(43) Pub. Date: Dec. 1, 2011

(54) SMALL-SIZE BASE STATION AND COMMUNICATION CONTROL SYSTEM

(76) Inventors: Mitsuru Hirakawa, Osaka (JP); Kenichi Murakami, Osaka (JP)

(21) Appl. No.: 13/131,202

(22) PCT Filed: Nov. 5, 2009
(86) PCT No.: PCT/JP2009/005865

§ 371 Date: Aug. 10, 2011

(30) Foreign Application Priority Data
Nov. 25, 2008 (JP) 2008-300225
Nov. 25, 2008 (JP) 2008-300226
Oct. 29, 2009 (JP) 2009-248443

(51) Int. Cl. H04W 88/08; H04W 28/00

(52) U.S. Cl. 455/422.1; 455/561

(57) ABSTRACT

A small-size base station is obtained that allows an authorized user to reliably perform communication via the small-size base station by avoiding a mobile communication terminal of a third person from being connected to the small-size base station. A femtocell base station 101F is the small-size base station that performs transmission and reception of radio waves with a mobile phone 110 located within a femtocell 103F, and includes a registering unit 132 registering an IMSI of a mobile phone 110X allowed to access the femtocell base station 101F; and a determining unit 131 determining whether an IMSI of a mobile phone 110 accessing the femtocell base station 101F is registered in the registering unit 132, and thereby determines whether the mobile phone 110 is a registered terminal or unregistered terminal. Access by an unregistered terminal to the femtocell base station 101F is limited based on a result of the determination made by the determining unit 131.

### RELATED APPLICATIONS

This application is the U.S. National Phase under 35 U.S.C. §371 of International Application No. PCT/JP2009/005865, filed on Nov. 5, 2009, which in turn claims the benefit of Japanese Application Nos. 2008-300226, filed on Nov. 25, 2008, 2008-300225, filed on Nov. 25, 2008 and 2009-248443, filed on Oct. 29, 2009, the disclosures of which Applications are incorporated by reference herein.

### TECHNICAL FIELD

The present invention relates to a small-size base station and a communication control system.

### BACKGROUND ART

Communications by mobile phones use radio waves. Thus, even within a communication coverage area, in a radio shadow area where radio waves from an outdoor base station (hereinafter, referred to as a “macrocell base station”) are difficult to reach (or do not reach), communications by mobile phones cannot be performed. Hence, in order that communications by mobile phones can be performed even in a radio shadow area, the construction of a communication system using a small-size base station is considered.

In this communication system, a small-size base station (hereinafter, referred to as a “femtocell base station”) having, as its coverage area, a very small cell (a femtocell) with a radius of the order of several meters to several tens of meters is installed in a radio shadow area. In addition, the femtocell base station is connected to a mobile communication network of a mobile service provider through a wire communication line. Therefore, mobile phones in the radio shadow area are connected to the mobile communication network through the femtocell base station and the wire communication line. As a result, even in the radio shadow area, communications by mobile phones can be performed.

In addition, when communication is performed via the femtocell base station, the load on the communication network of the mobile service provider is reduced. Hence, service such as lowering communication fees over communication performed via a macrocell base station is expected.

Note that the following Patent Literature 1 discloses a communication system in which, by transmitting a jamming signal to a mobile phone located in a specific area, wireless communication performed between the mobile phone and a base station is restricted.

### CITATION LIST

### Patent Literature

Patent Literature 1: Japanese Unexamined Patent Application No. 2004-15412

### SUMMARY OF INVENTION

### Technical Problems

Although, as described above, it is premised that a femtocell base station is installed in a radio shadow area, a situation is also assumed in which a femtocell base station is installed in an area where radio waves from a macrocell base station sufficiently reach (i.e., in a macrocell).

When a femtocell base station is installed in a home, a femtocell of the femtocell base station may extend around the home. In this case, if the intensity of radio waves from the femtocell base station is higher than the intensity of radio waves from a macrocell base station, then a mobile phone of a third person who has happened to walk by the home or a mobile phone of a resident next to the home is connected to the femtocell base station. In addition, even if the intensity of radio waves is set to a level weak enough for the femtocell to not extend around the home, a mobile phone of a visitor to the home is connected to the femtocell base station.

Here, in the femtocell base station, in many cases, the number of mobile phones that can simultaneously perform communication (the number of mobile phones accommodated) is limited to about several mobile phones. Therefore, when the number of third persons' mobile phones simultaneously connected to the femtocell base station is large, the number of mobile phones accommodated is occupied by the third persons' mobile phones, resulting in a situation in which a mobile phone of a resident of the home who is an authorized user cannot be connected to the femtocell base station. In this case, despite the fact that the resident of the home has the femtocell base station installed in his/her home, the resident cannot perform low rate communication via the femtocell base station.

The present invention is made in view of such circumstances, and an object of the present invention is therefore to obtain a small-size base station and a communication control system that allow an authorized user to reliably perform communication via the small-size base station by avoiding a mobile communication terminal of a third person from being connected to the small-size base station.

### Solution to Problem

A small-size base station according to a first aspect of the present invention performs transmission and reception of radio waves with a mobile communication terminal located within its coverage area, and includes: a registering unit that registers unique identification information of a mobile communication terminal that is allowed to access the small-size base station; and a determining unit that determines whether unique identification information of a mobile communication terminal accessing the small-size base station is registered in the registering unit, and thereby determines whether the mobile communication terminal is a registered terminal or an unregistered terminal, and access by an unregistered terminal to the small-size base station is limited based on a result of the determination made by the determining unit.

According to the small-size base station according to the first aspect, the registering unit registers in advance unique identification information of a mobile communication terminal that is allowed to access the small-size base station. In addition, the determining unit determines whether unique identification information of a mobile communication terminal accessing the small-size base station is registered in the registering unit, and thereby determines whether the mobile communication terminal is a registered terminal or an unregistered terminal. If the mobile communication terminal accessing the small-size base station is determined by the determining unit to be an unregistered terminal, then access by the mobile communication terminal to the small-size base station is limited. As a result, a mobile communication terminal of a third person is avoided from being connected to the small-size base station, securing the number of mobile communication terminals accommodated, with which the small-size base station can perform simultaneous communications. Thus, an authorized user can reliably perform communication via the small-size base station.

A small-size base station according to a second aspect of the present invention is such that in the small-size base station according to the first aspect, in particular, the small-size base station further includes a processing unit that processes, based on a registration request received from a mobile communication terminal, registration of information about the mobile communication terminal in a predetermined apparatus in a mobile communication network, and when the mobile communication terminal having transmitted the registration request is determined by the determining unit to be a registered terminal, the processing unit performs a process for registering unique identification information of the mobile communication terminal in the predetermined apparatus, and when the mobile communication terminal having transmitted the registration request is determined by the determining unit to be an unregistered terminal, the processing unit performs a process for not registering unique identification information of the mobile communication terminal in the predetermined apparatus.

Here, the registration processed by the processing unit includes, for example, registration of location information (location registration) of a mobile communication terminal in an HLR or the like which is a predetermined apparatus, and registration (attach) of a mobile communication terminal in an MME or the like which is a predetermined apparatus.

According to the small-size base station according to the second aspect, the processing unit performs a process for registering unique identification information received from a registered terminal, in a predetermined apparatus in the mobile communication network. By registering the unique identification information, the registered terminal can perform communication via the small-size base station. On the other hand, the processing unit performs a process for not registering unique identification information received from an unregistered terminal, in the predetermined apparatus in the mobile communication network. By not registering the unique identification information, the unregistered terminal can be avoided from performing communication via the small-size base station.

A small-size base station according to a third aspect of the present invention is such that in the small-size base station according to the second aspect, in particular, when the mobile communication terminal having transmitted the registration request is determined by the determining unit to be an unregistered terminal, the processing unit transmits, as unique identification information of the mobile communication terminal, any predetermined value to the mobile communication network, in response to a unique identification information request transmitted from the mobile communication network to the mobile communication terminal, the any predetermined value being different than the unique identification information of the mobile communication terminal.

According to the small-size base station according to the third aspect, in response to a unique identification information request transmitted from the mobile communication network to an unregistered terminal, the processing unit transmits, as unique identification information of the unregistered terminal, any predetermined value different than the unique identification information of the unregistered terminal, to the mobile communication network. That is, for an unregistered terminal, false unique identification information is transmitted to the mobile communication network. By this, the result of authentication of the unregistered terminal is NG in a later authentication process, and thus, registration of the unregistered terminal can be rejected.

A small-size base station according to a fourth aspect of the present invention is such that in the small-size base station according to the second aspect, in particular, when the mobile communication terminal having transmitted the registration request is determined by the determining unit to be an unregistered terminal, the processing unit transmits, as an authentication response value from the mobile communication terminal, any predetermined value to the mobile communication network, in response to an authentication request transmitted from the mobile communication network to the mobile communication terminal, the any predetermine value being different than an authentication response value transmitted from the mobile communication terminal.

According to the small-size base station according to the fourth aspect, in response to an authentication request transmitted from the mobile communication network to an unregistered terminal, the processing unit transmits, as an authentication response value of the unregistered terminal, any predetermined value different than an authentication response value transmitted from the unregistered terminal, to the mobile communication network. That is, for an unregistered terminal, a false authentication response value is transmitted to the mobile communication network. By this, the result of authentication of the unregistered terminal is NG, and thus, registration of the unregistered terminal can be rejected.

A small-size base station according to a fifth aspect of the present invention is such that in the small-size base station according to the second aspect, in particular, when the mobile communication terminal having transmitted the registration request is determined by the determining unit to be an unregistered terminal, a registration reject with a reject cause is transmitted from the small-size base station to the mobile communication terminal, the reject cause indicating that a cell of the small-size base station is not an optimum cell.

According to the small-size base station according to the fifth aspect, a registration reject with a reject cause indicating that the cell of the small-size base station is not an optimum cell is transmitted to an unregistered terminal. Hence, the unregistered terminal having received the registration reject, searches for an optimum cell other than the cell of the small-size base station. Accordingly, when the unregistered terminal is also located in a cell (e.g., a macrocell) other than the cell of the small-size base station, the unregistered terminal identifies the macrocell as an optimum cell and thus can perform communication via a macrocell base station.

A small-size base station according to a sixth aspect of the present invention is such that in the small-size base station according to the second aspect, in particular, when the mobile communication terminal having transmitted the registration request is determined by the determining unit to be an unregistered terminal, a registration reject with a reject cause is transmitted from the small-size base station to the mobile communication terminal, the reject cause indicating that the mobile communication terminal does not belong to a terminal group that is allowed to access.

According to the small-size base station according to the sixth aspect, a registration reject with a reject cause indicating that a mobile communication terminal does not belong to a terminal group that is allowed to access is transmitted to an unregistered terminal. Hence, the unregistered terminal having received the registration reject gives up access to the small-size base station and starts searching for a cell other than the cell of the small-size base station. Accordingly, when the unregistered terminal is also located in a cell (e.g., a macrocell) other than the cell of the small-size base station, the unregistered terminal identifies the macrocell as an optimum cell and thus can perform communication via a macrocell base station.

A small-size base station according to a seventh aspect of the present invention is such that in the small-size base station according to the second aspect, in particular, when unique identification information is included in the registration request received from the mobile communication terminal, the determining unit determines whether the mobile communication terminal is a registered terminal or an unregistered terminal, based on the unique identification information.

According to the small-size base station according to the seventh aspect, when unique identification information is included in a registration request, the determining unit determines whether the mobile communication terminal is a registered terminal or an unregistered terminal, based on the unique identification information. When, as a result of the determination, the mobile communication terminal is an unregistered terminal, there is no need to perform transmission and reception of a unique identification information request and a response thereto and an authentication request and a response thereto between the mobile communication network and the mobile communication terminal. As a result, a reduction in the amount of data communicated can be achieved.

A small-size base station according to an eighth aspect of the present invention is such that in the small-size base station according to the first aspect, in particular, the unique identification information is an IMSI.

According to the small-size base station according to the eighth aspect, by using an IMSI unique to each mobile communication terminal as unique identification information, the determining unit can make an accurate determination between a registered terminal and an unregistered terminal.

A communication control system according to a ninth aspect of the present invention includes: a mobile communication terminal; and a small-size base station that performs transmission and reception of radio waves with a mobile communication terminal located within its coverage area, and the small-size base station includes: a registering unit that registers unique identification information of a mobile communication terminal that is allowed to access the small-size base station; and a determining unit that determines whether unique identification information of a mobile communication terminal accessing the small-size base station is registered in the registering unit, and thereby determines whether the mobile communication terminal is a registered terminal or an unregistered terminal, and access by an unregistered terminal to the small-size base station is limited based on a result of the determination made by the determining unit.

According to the communication control system according to the ninth aspect, unique identification information of a mobile communication terminal that is allowed to access the small-size base station is registered in advance in the registering unit. In addition, the determining unit determines whether unique identification information of a mobile communication terminal accessing the small-size base station is registered in the registering unit, and thereby determines whether the mobile communication terminal is a registered terminal or an unregistered terminal. If the mobile communication terminal accessing the small-size base station is determined by the determining unit to be an unregistered terminal, then access by the mobile communication terminal to the small-size base station is limited. As a result, a mobile communication terminal of a third person is avoided from being connected to the small-size base station, securing the number of mobile communication terminals accommodated, with which the small-size base station can perform simultaneous communications. Thus, an authorized user can reliably perform communication via the small-size base station.

A small-size base station according to a tenth aspect of the present invention performs transmission and reception of radio waves with a mobile communication terminal located within its coverage area, and includes: an antenna; a control unit that controls directivity of the antenna; a registering unit that registers unique identification information of a mobile communication terminal that is allowed to access the small-size base station; an identifying unit that identifies a direction of arrival of radio waves from a mobile communication terminal to the antenna; and a determining unit that determines whether unique identification information of a mobile communication terminal accessing the small-size base station is registered in the registering unit, and thereby determines whether the mobile communication terminal is a registered terminal or an unregistered terminal, and when the mobile communication terminal accessing the small-size base station is determined by the determining unit to be an unregistered terminal, the control unit steers a beam in a direction of arrival of radio waves from the mobile communication terminal identified by the identifying unit, the beam having a lower intensity than beam intensities for directions different than the direction of arrival of radio waves.

According to the small-size base station according to the tenth aspect, when a mobile communication terminal accessing the small-size base station is determined by the determining unit to be an unregistered terminal, the control unit steers a beam (desirably, a null) in a direction of arrival of radio waves from the mobile communication terminal identified by the identifying unit, the beam having a lower intensity than beam intensities for directions different than the direction of arrival of radio waves. By steering a beam with a low intensity towards a mobile communication terminal which is an unregistered terminal, the intensity of radio waves from the small-size base station to the mobile communication terminal is weakened and thus the mobile communication terminal cannot perform communication via the small-size base station. As a result, a mobile communication terminal of a third person is avoided from being connected to the small-size base station, securing the number of mobile communication terminals accommodated, with which the small-size base station can perform simultaneous communications. Thus, an authorized user can reliably perform communication via the small-size base station.

A small-size base station according to an eleventh aspect of the present invention is such that in the small-size base station according to the tenth aspect, in particular, when the mobile communication terminal accessing the small-size base station is determined by the determining unit to be a registered terminal, the control unit steers a beam in a direction of arrival of radio waves from the mobile communication terminal identified by the identifying unit, the beam having a higher intensity than beam intensities for directions different than the direction of arrival of radio waves.

According to the small-size base station according to the eleventh aspect, when a mobile communication terminal accessing the small-size base station is determined by the determining unit to be a registered terminal, the control unit steers a beam (desirably, a peak) in a direction of arrival of radio waves from the mobile communication terminal identified by the identifying unit, the beam having a higher intensity than beam intensities for directions different than the direction of arrival of radio waves. By steering a beam with a high intensity towards a mobile communication terminal which is a registered terminal, the intensity of radio waves from the small-size base station to the mobile communication terminal is strengthened. Thus, even when radio waves from a macrocell base station reach, the mobile communication terminal can be reliably connected to the small-size base station but not to the macrocell base station. As a result, an authorized user can surely obtain benefits (e.g., low rate communication service) brought about by communication via the small-size base station.

A small-size base station according to a twelfth aspect of the present invention is such that in the small-size base station according to the tenth aspect, in particular, the unique identification information is an IMSI (International Mobile Subscriber Identity), and the small-size base station requests a mobile communication terminal accessing the small-size base station for an IMSI of the mobile communication terminal.

According to the small-size base station according to the twelfth aspect, by using an IMSI unique to each mobile communication terminal as unique identification information, the determining unit can make an accurate determination between a registered terminal and an unregistered terminal. In addition, by the small-size base station requesting a mobile communication terminal for an IMSI, the determining unit can perform a determination process using an IMSI sent as a response from the mobile communication terminal.

A small-size base station according to a thirteenth aspect of the present invention is such that in the small-size base station according to the tenth aspect, in particular, the antenna has a plurality of antenna elements, and the small-size base station further includes a computing unit that computes weights by which outputs from the respective antenna elements are multiplied, based on a result of a determination made by the determining unit and a direction of arrival of radio waves identified by the identifying unit.

According to the small-size base station according to the thirteenth aspect, weights by which outputs from the respective antenna elements are multiplied are determined by computations performed by the computing unit. Thus, compared with the case of selecting optimum weights from among a plurality of patterns which are prepared in advance, the accuracy of a beamforming direction can be improved.

A small-size base station according to a fourteenth aspect of the present invention is such that in the small-size base station according to the tenth aspect, in particular, the antenna has a plurality of antenna elements, and the small-size base station further includes: a memory unit that memorizes a plurality of patterns regarding weights by which outputs from the respective antenna elements are multiplied; and a selecting unit that selects weights by which outputs from the respective antenna elements are multiplied, from among the plurality of patterns based on a result of a determination made by the determining unit and a direction of arrival of radio waves identified by the identifying unit.

According to the small-size base station according to the fourteenth aspect, since optimum weights are selected by the selecting unit from among a plurality of patterns which are memorized in advance, the circuit size of arithmetic circuitry can be reduced.

A communication control system according to a fifteenth aspect of the present invention includes: a mobile communication terminal; and a small-size base station that performs transmission and reception of radio waves with a mobile communication terminal located within its coverage area, and the small-size base station includes: a control unit that controls directivity of an antenna of the small-size base station; a registering unit that registers unique identification information of a mobile communication terminal that is allowed to access the small-size base station; an identifying unit that identifies a direction of arrival of radio waves from a mobile communication terminal to the antenna; and a determining unit that determines whether unique identification information of a mobile communication terminal accessing the small-size base station is registered in the registering unit, and thereby determines whether the mobile communication terminal is a registered terminal or an unregistered terminal, and when the mobile communication terminal accessing the small-size base station is determined by the determining unit to be an unregistered terminal, the control unit steers a beam in a direction of arrival of radio waves from the mobile communication terminal identified by the identifying unit, the beam having a lower intensity than beam intensities for directions different than the direction of arrival of radio waves.

According to the communication control system according to the fifteenth aspect, when a mobile communication terminal accessing the small-size base station is determined by the determining unit to be an unregistered terminal, the control unit steers a beam (desirably, a null) in a direction of arrival of radio waves from the mobile communication terminal identified by the identifying unit, the beam having a lower intensity than beam intensities for directions different than the direction of arrival of radio waves. By steering a beam with a low intensity towards a mobile communication terminal which is an unregistered terminal, the intensity of radio waves from the small-size base station to the mobile communication terminal is weakened and thus the mobile communication terminal cannot perform communication via the small-size base station. As a result, a mobile communication terminal of a third person is avoided from being connected to the small-size base station, securing the number of mobile communication terminals accommodated, with which the small-size base station can perform simultaneous communications. Thus, an authorized user can reliably perform communication via the small-size base station.

### Advantageous Effects of Invention

According to the present invention, since a mobile communication terminal of a third person is avoided from being connected to a small-size base station, an authorized user can reliably perform communication via the small-size base station.

### BRIEF DESCRIPTION OF DRAWINGS

FIG. 1 is a diagram schematically showing an overall configuration of a communication system according to a first embodiment of the present invention.

FIG. 2 is a block diagram showing a functional configuration of a femtocell base station.

FIG. 3 is a diagram schematically showing the flow of a connection process in LTE.

FIG. 4 is a diagram showing the flow of processes performed when there is a location registration request from a mobile phone which is a registered terminal.

FIG. 5 is a diagram showing a first example of the flow of processes performed when there is a location registration request from a mobile phone which is an unregistered terminal.

FIG. 6 is a diagram showing a second example of the flow of processes performed when there is a location registration request from a mobile phone which is an unregistered terminal.

FIG. 7 is a diagram showing a third example of the flow of processes performed when there is a location registration request from a mobile phone which is an unregistered terminal.

FIG. 8 is a diagram showing a fourth example of the flow of processes performed when there is a location registration request from a mobile phone which is an unregistered terminal.

FIG. 9 is a diagram showing a fifth example of the flow of processes performed when there is a location registration request from a mobile phone which is an unregistered terminal.

FIG. 10 is a flowchart showing the flow of processes performed when the example shown in FIG. 9 is applied in combination with the examples shown in FIGS. 4 to 8.

FIG. 11 is a diagram showing the flow of processes performed when there is an attach request from a mobile phone which is a registered terminal.

FIG. 12 is a diagram showing a first example of the flow of processes performed when there is an attach request from a mobile phone which is an unregistered terminal.

FIG. 13 is a diagram showing a second example of the flow of processes performed when there is an attach request from a mobile phone which is an unregistered terminal.

FIG. 14 is a diagram showing a third example of the flow of processes performed when there is an attach request from a mobile phone which is an unregistered terminal.

FIG. 15 is a diagram showing a fourth example of the flow of processes performed when there is an attach request from a mobile phone which is an unregistered terminal.

FIG. 16 is a diagram showing a fifth example of the flow of processes performed when there is an attach request from a mobile phone which is an unregistered terminal.

FIG. 17 is a flowchart showing the flow of processes performed when the example shown in FIG. 16 is applied in combination with the examples shown in FIGS. 11 to 15.

FIG. 18 is a diagram simply showing the flow of processes performed when there is a location registration request for a CS domain from a mobile phone which is a registered terminal.

FIG. 19 is a diagram showing the flow of processes performed when there is a location registration request for the CS domain from a mobile phone which is an unregistered terminal.

FIG. 20 is a diagram simply showing the flow of processes performed when there is an attach request for a PS domain from a mobile phone which is a registered terminal.

FIG. 21 is a diagram showing the flow of processes performed when there is an attach request for the PS domain from a mobile phone which is an unregistered terminal.

FIG. 22 is a diagram schematically showing an overall configuration of a communication system according to a third embodiment of the present invention.

FIG. 23 is a block diagram showing a configuration of a femtocell base station.

FIG. 24 is a block diagram showing a first exemplary configuration of a weight determining unit and a weight multiplying unit.

FIG. 25 is a block diagram showing a second exemplary configuration of the weight determining unit and the weight multiplying unit.

FIG. 26 is a diagram schematically showing the flow of a connection process in LTE.

FIG. 27 is a diagram showing the flow of processes performed when there is a location registration request from a mobile phone which is a registered terminal.

FIG. 28 is a diagram showing the flow of processes performed when there is a location registration request from a mobile phone which is an unregistered terminal.

FIG. 29 is a diagram showing the flow of processes performed when there is an attach request from a mobile phone which is a registered terminal.

FIG. 30 is a diagram showing the flow of processes performed when there is an attach request from a mobile phone which is an unregistered terminal.

FIGS. 31A and 31B are schematic diagrams of superposition of transmit beams transmitted every certain period of time from an antenna, the directivity of which is controlled by a beam control unit.

### MODE FOR CARRYING OUT THE INVENTION

Embodiments of the present invention will be described in detail below using the drawings. Note that those elements denoted by the same reference numerals in different drawings indicate the same or corresponding elements.

### First Embodiment

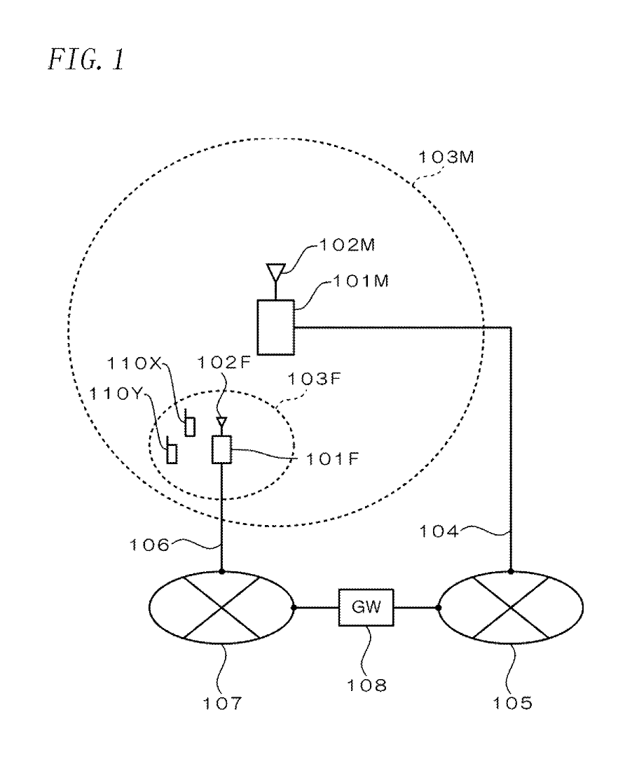

FIG. 1 is a diagram schematically showing an overall configuration of a communication system according to a first embodiment of the present invention. A small-size base station 101F is installed in, for example, a user's home. The small-size base station 101F has, as its coverage area, a very small cell with a radius of the order of several meters to several tens of meters. In addition, in the small-size base station 101F, the number of mobile phones that can simultaneously perform communication (the number of mobile phones accommodated) is limited to about several mobile phones (e.g., eight mobile phones). In this specification, the coverage area of the small-size base station is hereinafter referred to as the “femtocell” and the small-size base station is hereinafter referred to as the “femtocell base station”. Referring to FIG. 1, a femtocell 103F which is a coverage area of the femtocell base station 101F is provided around the femtocell base station 101F. A macrocell base station 101M is installed, for example, outdoors. A macrocell 103M which is a coverage area of the macrocell base station 101M is provided around the macrocell base station 101M.

In the example shown in FIG. 1, the femtocell 103F is included in the macrocell 103M. Therefore, mobile phones 110 (denoted by reference numerals 110X and 110Y in FIG. 1) located within the femtocell 103F can perform transmission and reception of radio waves with an antenna 102F of the femtocell base station 101F, and can also perform transmission and reception of radio waves with an antenna 102M of the macrocell base station 101M. In the following description, it is assumed that the mobile phone 100X is a mobile phone owned by an authorized user of the femtocell base station 101F, and the mobile phone 110Y is a mobile phone owned by a third person who is not an authorized user of the femtocell base station 101F.

The macrocell base station 101M is connected to a mobile communication network 105 of a mobile service provider through a communication line 104. The femtocell base station 101F is connected to an IP (Internet Protocol) network 107 through a wire communication line 106 such as an optical fiber or a metal cable. The IP network 107 is connected to the mobile communication network 105 through a gateway 108.

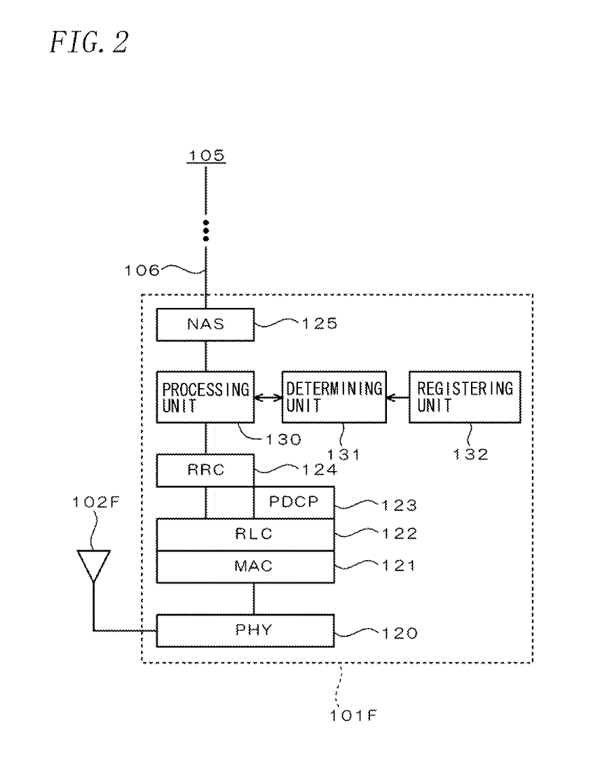

FIG. 2 is a block diagram showing a functional configuration of the femtocell base station 101F. The femtocell base station 101F is a base station that supports LTE (Long Term Evolution). In LTE, OFDMA (Orthogonal Frequency Division Multiple Access) is employed as a downlink wireless access scheme, and SC-FDMA (Single Carrier—Frequency Division Multiple Access) is employed as an uplink wireless access scheme.

The femtocell base station 101F includes a PHY processing unit 120, a MAC processing unit 121, an RLC processing unit 122, a PDCP processing unit 123, an RRC processing unit 124, and a NAS processing unit 125. The PHY processing unit 120 processes a physical layer of a wireless protocol of a mobile phone 110. The MAC processing unit 121, the RLC processing unit 122, the PDCP processing unit 123, the RRC processing unit 124, and the NAS processing unit 125 respectively process a MAC (Medium Access Control) sub-layer, an RLC (Radio Link Control) sub-layer, a PDCP (Packet Data Convergence Protocol) sub-layer, an RRC (Radio Resource Control) layer, and a NAS (Non Access Stratum) layer of the wireless protocol of the mobile phone 110.

In addition, the femtocell base station 101F includes a processing unit 130, a determining unit 131, and a registering unit 132. The registering unit 132 registers in advance the IMSI (International Mobile Subscriber Identity) of a mobile phone 110 that is allowed to access the femtocell base station 101F (in this example, the mobile phone 110X). Any method can be employed for registering the IMSI in the registering unit 132. For example, the IMSI can be registered when the femtocell base station 101F is purchased, by using a dedicated terminal at the purchasing store. Alternatively, the IMSI can also be registered via the Internet using dedicated application software, after installing the femtocell base station 101F in a home. Alternatively, the IMSI of the mobile phone 110X can also be registered by connecting the mobile phone 110X to the femtocell base station 101F by wire or wireless.

The determining unit 131 compares the IMSI of a mobile phone 110 accessing the femtocell base station 101F with the IMSI registered in the registering unit 132. If the IMSI of the mobile phone 110 matches the IMSI registered in the registering unit 132, then the determining unit 131 determines that the mobile phone 110 is a registered terminal (i.e., the mobile phone 110X owned by an authorized user). On the other hand, if the IMSI of the mobile phone 110 does not match the IMSI registered in the registering unit 132, then the determining unit 131 determines that the mobile phone 110 is an unregistered terminal (i.e., the mobile phone 110Y owned by a third person).

The processing unit 130 performs processes such as location registration, based on the result of the determination made by the determining unit 131. A detail of the functionality of the processing unit 130 will be described later. Note that the processing unit 130, the determining unit 131, and the registering unit 132 may be included in the NAS processing unit 125. Note also that the NAS processing unit 125, the processing unit 130, the determining unit 131, and the registering unit 132 do not necessarily need to be mounted within the femtocell base station 101F, and may be mounted at any location within the communication system, as other apparatuses than the femtocell base station 101F.

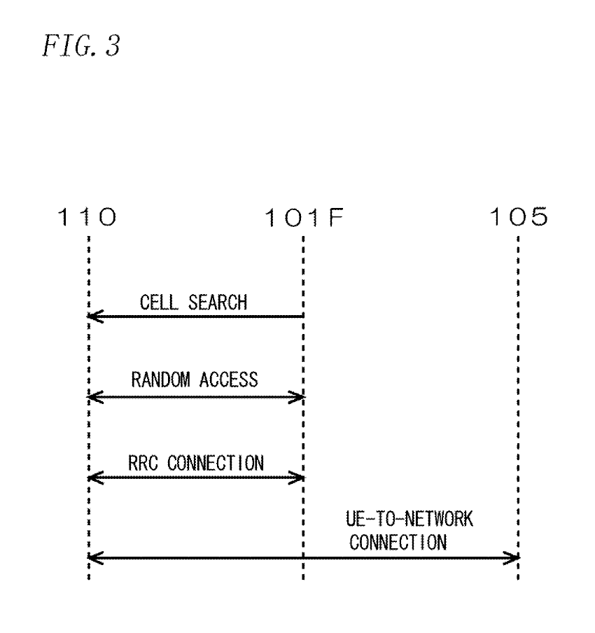

FIG. 3 is a diagram schematically showing the flow of a connection process in LTE. First, by a cell search, processes such as carrier wave frequency synchronization, radio frame synchronization, and cell ID identification are performed. Thereafter, system information such as a Master Information Block (MIB) and System Information Blocks (SIBs) is transmitted from the femtocell base station 101F to a mobile phone 110. In addition, by a peripheral cell search, a more optimum cell search is periodically performed.

Then, by random access, a correction to the transmission timing is made. Specifically, the mobile phone 110 generates a unique preamble sequence based on the SIBs received from the femtocell base station 101F, and transmits the preamble sequence towards the femtocell base station 101F. The femtocell base station 101F calculates a correction value of the transmission timing based on the received preamble sequence, and transmits the correction value to the mobile phone 110. The mobile phone 110 corrects the transmission timing based on the received correction value. In addition, a CR-ID (Contention Resolution-IDentifier) for performing contention determination is transmitted from the mobile phone 110 to the femtocell base station 101F. When the femtocell base station 101F receives the CR-ID normally, the femtocell base station 101F returns the CR-ID to the mobile phone 110 and transmits a unique ID (C-RNTI: Cell—Radio Network Temporary Identifier) for identifying the mobile phone 110 within the cell, to the mobile phone 110.

Then, by RRC (Radio Resource Control) connection, bearer establishment and radio resource allocation are performed. Specifically, first, an RRC connection request signal is transmitted from the mobile phone 110 to the femtocell base station 101F. The femtocell base station 101F having received the RRC connection request signal transmits setting information for establishing a control signal bearer (SRB1), to the mobile phone 110. When the mobile phone 110 has completed the establishment of a control signal bearer (SRB1), the mobile phone 110 transmits a setting complete signal to the femtocell base station 101F. Thereafter, the femtocell base station 101F transmits setting information for setting security mode, to the mobile phone 110. When the mobile phone 110 has completed the setting of security mode, the mobile phone 110 transmits a setting complete signal to the femtocell base station 101F. Then, the femtocell base station 101F transmits setting information for establishing a control signal bearer (SRB2) and a data signal bearer (DRB), to the mobile phone 110. When the mobile phone 110 has completed the establishment of a control signal bearer (SRB2) and a data signal bearer, the mobile phone 110 transmits a setting complete signal to the femtocell base station 101F.

Then, a connection between the mobile phone 110 and the mobile communication network 105 (a UE-to-network connection) is established. The UE-to-network connection includes processes such as location registration (i.e., a tracking area update), attach, call connection, and call release.

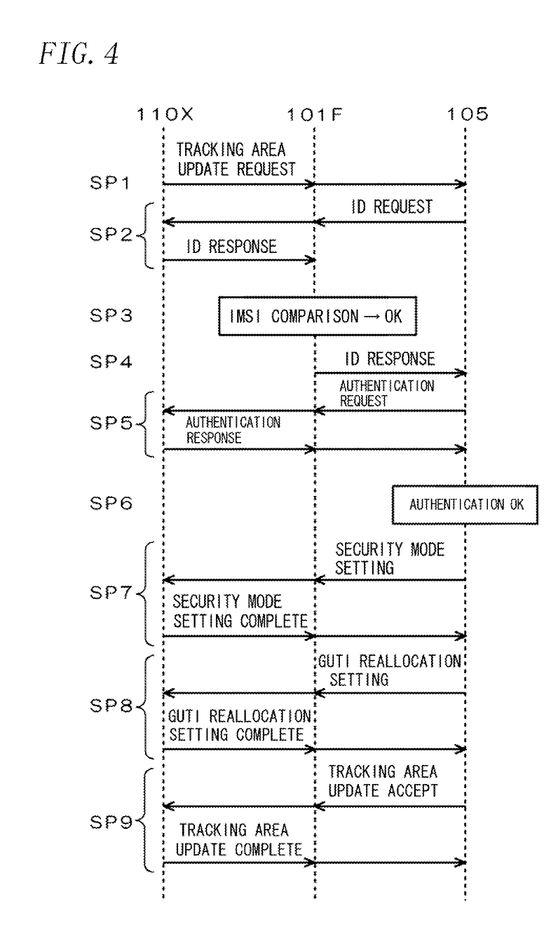

FIG. 4 is a diagram showing the flow of processes performed when there is a location registration request from the mobile phone 110X which is a registered terminal. First, at step SP1, a tracking area update request message (Tracking Area Update Request) is transmitted from the mobile phone 110X to the mobile communication network 105 (specifically, an HLR (Home Location Register)) through the femtocell base station 101F.

Then, at step SP2, an ID request message (Identity Request) for obtaining an IMSI is transmitted from the mobile communication network 105 to the mobile phone 110X through the femtocell base station 101F. Then, an ID response message (Identity Response) is transmitted from the mobile phone 110X to the femtocell base station 101F. The ID response message includes the IMSI of the mobile phone 110X.

Then, at step SP3, the determining unit 131 (see FIG. 2) determines whether the IMSI included in the received ID response message matches the IMSI registered in the registering unit 132. Since the IMSI of the mobile phone 110X is already registered in the registering unit 132, the result of the determination made by the determining unit 131 is “OK”.

In this case, next, at step SP4, the ID response message received from the mobile phone 110X is transmitted from the processing unit 130 to the mobile communication network 105. The ID response message includes the IMSI of the mobile phone 110X.

Then, at step SP5, an authentication request message (Authentication Request) is transmitted from the mobile communication network 105 to the mobile phone 110X through the femtocell base station 101F. In addition, an authentication response message (Authentication Response) is transmitted from the mobile phone 110X to the mobile communication network 105 through the femtocell base station 101F. The authentication response message includes an authentication response value generated by the mobile phone 110X based on its IMSI.

Then, at step SP6, authentication as to whether the authentication response value received at step SP5 is a proper one is performed. That is, an authentication response value generated by the mobile communication network 105 itself based on the IMSI received at step SP4 is compared with the authentication response value received at step SP5. If they match, then it is authenticated that the authentication response value received at step SP5 is a proper one. In the case of this example, the authentication response value received at step SP5 is a proper one, and thus, the result of the authentication at step SP6 is “OK”.

Then, at step SP7, a setting information message (Security Mode Command) for setting security mode is transmitted from the mobile communication network 105 to the mobile phone 110X through the femtocell base station 101F. In addition, a security mode setting complete message (Security Mode Complete) is transmitted from the mobile phone 110X to the mobile communication network 105 through the femtocell base station 101F.

Then, at step SP8, a setting message (GUTI Reallocation Command) for reallocating a GUTI (Global Unique Temporary Identifier) is transmitted from the mobile communication network 105 (specifically, an EPC (Evolved Packet Core)) to the mobile phone 110X through the femtocell base station 101F. In addition, a GUTI reallocation complete message (GUTI Reallocation Complete) is transmitted from the mobile phone 110X to the mobile communication network 105 through the femtocell base station 101F.

Then, at step SP9, a tracking area update accept message (Tracking Area Update Accept) is transmitted from the mobile communication network 105 to the mobile phone 110X through the femtocell base station 101F. In addition, a tracking area update complete message (Tracking Area Update Complete) is transmitted from the mobile phone 110X to the mobile communication network 105 through the femtocell base station 101F.

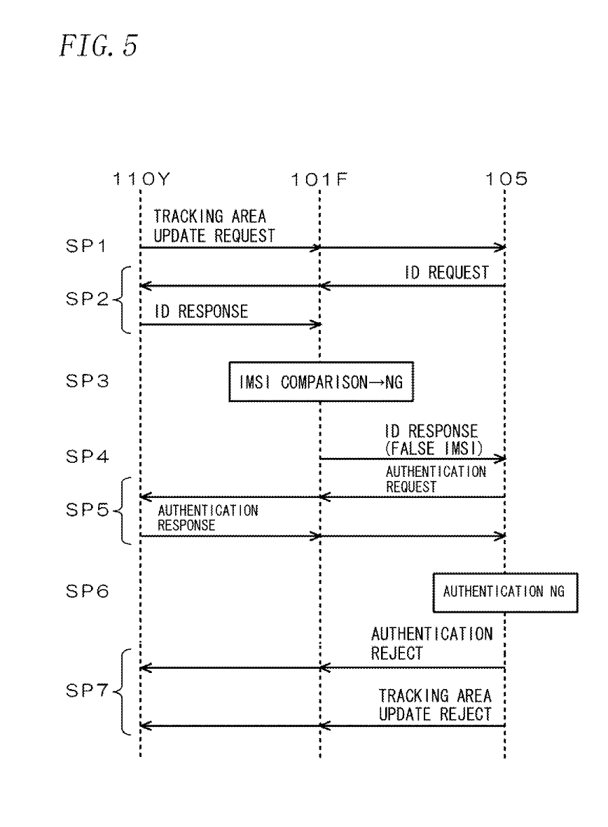

FIG. 5 is a diagram showing a first example of the flow of processes performed when there is a location registration request from the mobile phone 110Y which is an unregistered terminal. First, at step SP1, a tracking area update request message is transmitted from the mobile phone 110Y to the mobile communication network 105 (specifically, the HLR) through the femtocell base station 101F.

Then, at step SP2, an ID request message for obtaining an IMSI is transmitted from the mobile communication network 105 to the mobile phone 110Y through the femtocell base station 101F. Then, an ID response message is transmitted from the mobile phone 110Y to the femtocell base station 101F. The ID response message includes the IMSI of the mobile phone 110Y.

Then, at step SP3, the determining unit 131 (see FIG. 2) determines whether the IMSI included in the received ID response message matches the IMSI registered in the registering unit 132. Since the IMSI of the mobile phone 110Y is not registered in the registering unit 132, the result of the determination made by the determining unit 131 is “NG”.

In this case, next, at step SP4, an ID response message including a false IMSI is transmitted from the processing unit 130 to the mobile communication network 105. Here, the false IMSI is any value different than the IMSI of the mobile phone 110Y and is generated by the processing unit 130.

Then, at step SP5, an authentication request message is transmitted from the mobile communication network 105 to the mobile phone 110Y through the femtocell base station 101F. In addition, an authentication response message is transmitted from the mobile phone 110Y to the mobile communication network 105 through the femtocell base station 101F. The authentication response message includes an authentication response value generated by the mobile phone 110Y based on its IMSI.

Then, at step SP6, authentication as to whether the authentication response value received at step SP5 is a proper one is performed. That is, an authentication response value generated by the mobile communication network 105 itself based on the IMSI (false IMSI) received at step SP4 is compared with the authentication response value received at step SP5. In the case of this example, they do not match, and thus, the result of the authentication at step SP6 is “NG”.

Then, at step SP7, an authentication reject message (Authentication Reject) and a tracking area update reject message (Tracking Area Update Reject) are transmitted from the mobile communication network 105 to the mobile phone 110Y through the femtocell base station 101F. Note, however, that in order to avoid the mobile phone 110Y from being processed as an unauthorized terminal, the transmission of an authentication reject message from the femtocell base station 101F to the mobile phone 110Y may be omitted. In addition, as the tracking area update reject cause, a reject cause (Reject Cause No. 15) indicating that the femtocell 103F is not an optimum cell is notified from the mobile communication network 105 to the mobile phone 110Y through the femtocell base station 101F. By this, the mobile phone 110Y searches for an optimum cell other than the femtocell 103F. In the example of FIG. 1, since the mobile phone 110Y is located not only in the femtocell 103F but also in the macrocell 103M, the mobile phone 110Y camps on the macrocell 103M. Note that, for the tracking area update reject cause, a reject cause (Reject Cause No. 25) indicating that the mobile phone 110Y does not belong to a terminal group (CSG: Closed Subscriber Group) that is allowed to access the femtocell base station 101F may be notified from the femtocell base station 101F to the mobile phone 110Y.

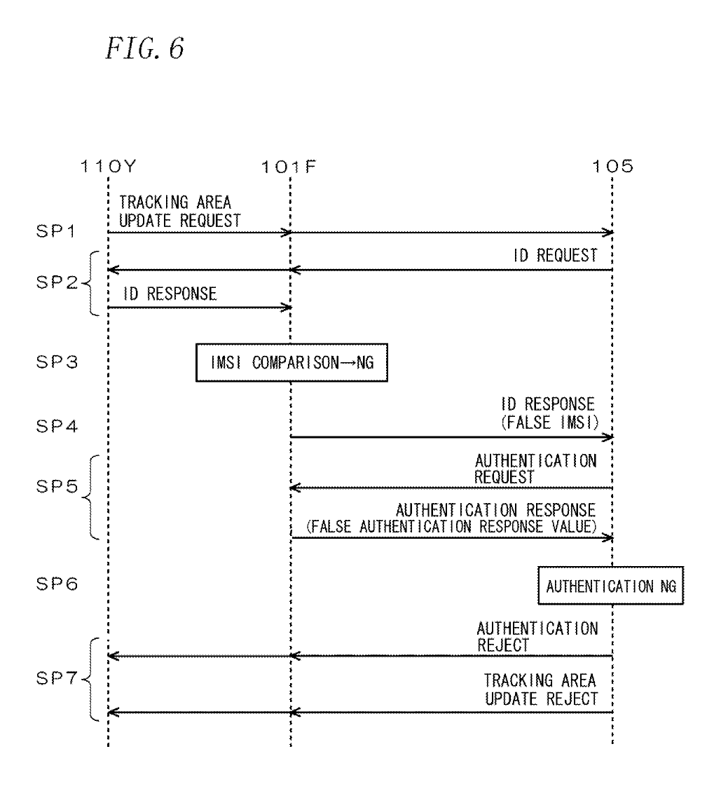

FIG. 6 is a diagram showing a second example of the flow of processes performed when there is a location registration request from the mobile phone 110Y which is an unregistered terminal. At step SP5, the transmission and reception of an authentication request message and an authentication response message performed between the femtocell base station 101F and the mobile phone 110Y are omitted. In this case, an authentication response message transmitted from the femtocell base station 101F to the mobile communication network 105 includes a false authentication response value. Here, the false authentication response value is any value different than an authentication response value generated based on the IMSI of the mobile phone 110Y, and is generated by the processing unit 130. Other processes are the same as those in FIG. 5.

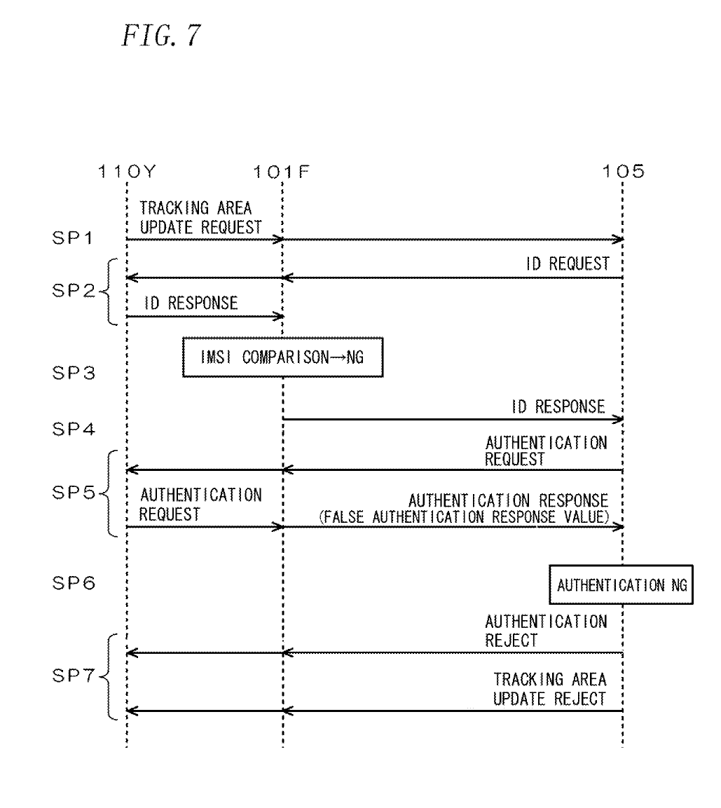

FIG. 7 is a diagram showing a third example of the flow of processes performed when there is a location registration request from the mobile phone 110Y which is an unregistered terminal. Those processes before step SP3 are the same as those in FIG. 5.

Then, at step SP4, an ID response message received from the mobile phone 110Y is transmitted from the processing unit 130 to the mobile communication network 105. The ID response message includes the IMSI of the mobile phone 110Y (a proper IMSI but not a false IMSI).

Then, at step SP5, an authentication request message is transmitted from the mobile communication network 105 to the mobile phone 110Y through the femtocell base station 101F. In addition, an authentication response message is transmitted from the mobile phone 110Y to the femtocell base station 101F. The authentication response message includes an authentication response value generated by the mobile phone 110Y based on its IMSI. The processing unit 130 replaces the authentication response value with a different false authentication response value, and then, transmits an authentication response message to the mobile communication network 105. Those processes after step SP6 are the same as those in FIG. 5.

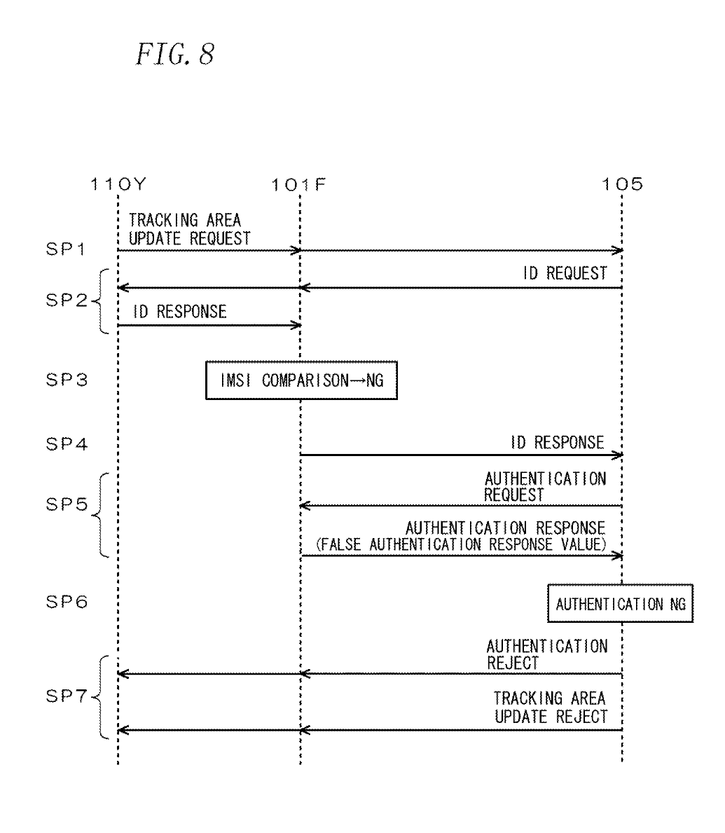

FIG. 8 is a diagram showing a fourth example of the flow of processes performed when there is a location registration request from the mobile phone 110Y which is an unregistered terminal. At step SP5, the transmission and reception of an authentication request message and an authentication response message performed between the femtocell base station 101F and the mobile phone 110Y are omitted. In this case, an authentication response message transmitted from the femtocell base station 101F to the mobile communication network 105 includes a false authentication response value. Here, the false authentication response value is any value different than an authentication response value generated based on the IMSI of the mobile phone 110Y, and is generated by the processing unit 130. Other processes are the same as those in FIG. 7.

In the above description, the determining unit 131 compares an IMSI included in an ID response message which is returned from a mobile phone 110 in response to an ID request message transmitted from the mobile communication network 105, with the IMSI registered in the registering unit 132. Meanwhile, in LTE, there may be a case in which the IMSI of the mobile phone 110 may be included in a tracking area update request message. Therefore, in this case, the determining unit 131 can compare the IMSI included in the tracking area update request message, with the IMSI registered in the registering unit 132.

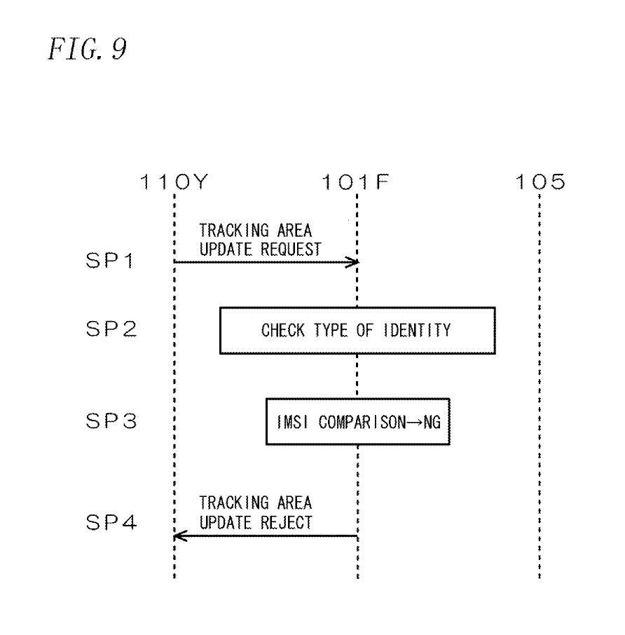

FIG. 9 is a diagram showing a fifth example of the flow of processes performed when there is a location registration request from the mobile phone 110Y which is an unregistered terminal. First, at step SP1, a tracking area update request message is transmitted from the mobile phone 110Y to the femtocell base station 101F.

Then, at step SP2, the processing unit 130 checks a predetermined parameter (specifically, Type of identity in EPS mobile identity IE) in the tracking area update request message. When the value of this parameter is a predetermined value (001), it indicates that the IMSI of the mobile phone 110Y is included in the tracking area update request message.

In this case, next, at step SP3, the determining unit 131 extracts an IMSI from the tracking area update request message and determines whether the IMSI matches the IMSI registered in the registering unit 132. Since the IMSI of the mobile phone 110Y is not registered in the registering unit 132, the result of the determination made by the determining unit 131 is “NG”.

Then, at step SP4, a tracking area update reject message is transmitted from the femtocell base station 101F to the mobile phone 110Y. In addition, as with that described above, as the tracking area update reject cause, a reject cause (Reject Cause No. 15) indicating that the femtocell 103F is not an optimum cell is notified from the femtocell base station 101F to the mobile phone 110Y. By this, the mobile phone 110Y searches for an optimum cell other than the femtocell 103F. In the example of FIG. 1, since the mobile phone 110Y is located not only in the femtocell 103F but also in the macrocell 103M, the mobile phone 110Y camps on the macrocell 103M. Note that, as with that described above, for the tracking area update reject cause, a reject cause (Reject Cause No. 25) indicating that the mobile phone 110Y does not belong to a terminal group that is allowed to access the femtocell base station 101F may be notified from the femtocell base station 101F to the mobile phone 110Y.

Note that, as shown in FIG. 9, the transmission and reception of an ID request message and an ID response message, the transmission and reception of an authentication request message and an authentication response message, and the like, performed between the mobile phone 110Y which is an unregistered terminal and the mobile communication network 105 can be omitted.

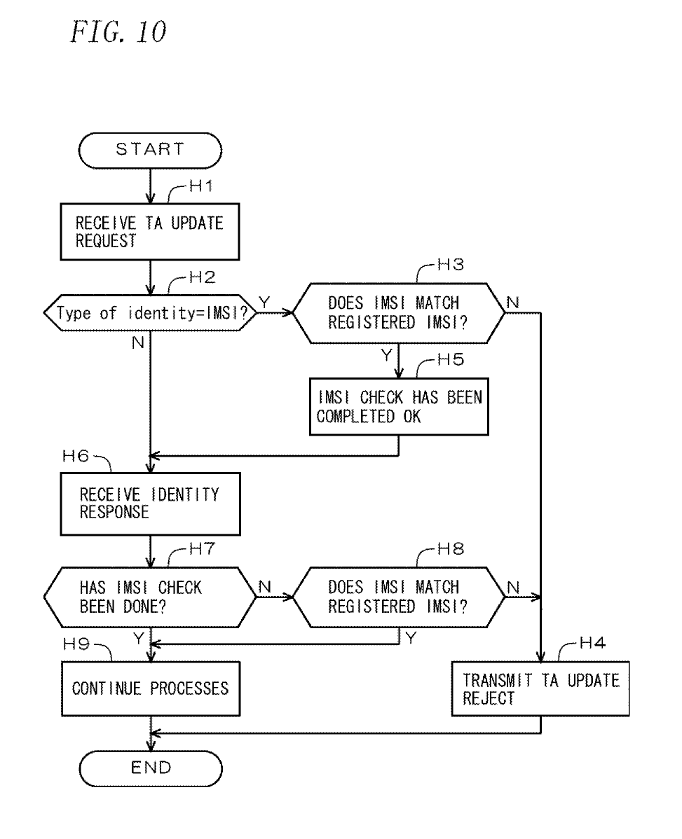

FIG. 10 is a flowchart showing the flow of processes performed when the example shown in FIG. 9 is applied in combination with the examples shown in FIGS. 4 to 8. The flow of processes at steps H1→H2→H3→H4 is the same as the flow of processes at steps SP1→SP2→SP3→SP4 shown in FIG. 9.

If an IMSI is not included in a tracking area update request message (i.e., if the result of determination at step H2 is “NO”), then a tracking area update request message is transmitted from the femtocell base station 101F to the mobile communication network 105, and thereafter, the same processes as those at step SP2 shown in FIGS. 4 to 8 are performed. By this, at step H6, the femtocell base station 101F receives an ID response message from a mobile phone 110.

If an IMSI extracted from the tracking area update request message matches the IMSI registered in the registering unit 132 (i.e., if the result of determination at step H3 is “YES”), then at step H5, the processing unit 130 holds the fact that an IMSI check has been completed (and the result of the check is “OK”) as predetermined flag information. Thereafter, a tracking area update request message is transmitted from the femtocell base station 101F to the mobile communication network 105, and then, the same processes as those at step SP2 shown in FIGS. 4 to 8 are performed. By this, at step H6, the femtocell base station 101F receives an ID response message from the mobile phone 110.

Subsequent to step H6, at step H7, the processing unit 130 determines whether an IMSI check has been completed. This determination is made based on the above-described flag information. If an IMSI check has not been completed then processing proceeds to step H8, and if completed then processing proceeds to step H9. If the result of determination at step H2 is “NO”, then processing proceeds in the order of steps H6→H7→H8. In addition, if the result of determination at step H3 is “YES”, then processing proceeds in the order of steps H5→H6→H7→H9.

At step H8, the same process as that at step SP3 shown in FIGS. 4 to 8 is performed. That is, the determining unit 131 determines whether an IMSI included in the ID response message received at step H6 matches the IMSI registered in the registering unit 132. If the result of the determination at step H8 is “YES”, then next, at step H9, those processes after step SP4 shown in FIG. 4 are performed. On the other hand, if the result of the determination at step H8 is “NO”, then next, at step H4, those processes after step SP4 shown in FIGS. 5 to 8 are performed.

Although the above description is made of processes performed when there is a tracking area update request (location registration request) from a mobile phone 110, when there is an attach request (Attach Request) from a mobile phone 110, too, the attach request can be processed in the same manner as above. In the attach request, the IMSI of the mobile phone 110X is registered in an MME (Mobility Management Entity) instead of in the HLR.

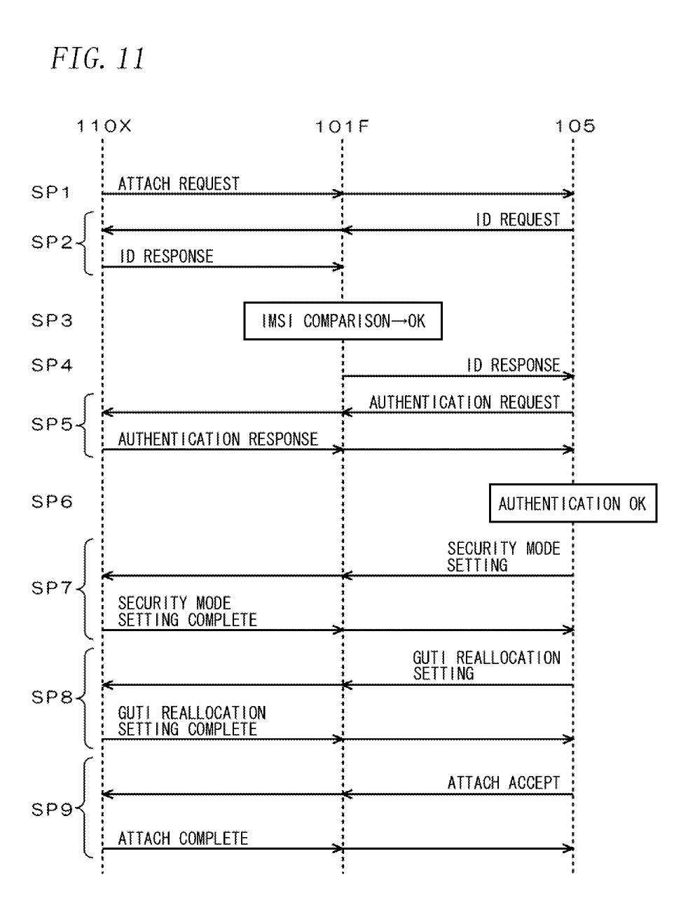

FIG. 11 is a diagram showing the flow of processes performed when there is an attach request from the mobile phone 110X which is a registered terminal. First, at step SP1, an attach request message (Attach Request) is transmitted from the mobile phone 110X to the mobile communication network 105 (specifically, the MME) through the femtocell base station 101F.

Then, at step SP2, an ID request message (Identity Request) for obtaining an IMSI is transmitted from the mobile communication network 105 to the mobile phone 110X through the femtocell base station 101F. Then, an ID response message (Identity Response) is transmitted from the mobile phone 110X to the femtocell base station 101F. The ID response message includes the IMSI of the mobile phone 110X.

Then, at step SP3, the determining unit 131 (see FIG. 2) determines whether the IMSI included in the received ID response message matches the IMSI registered in the registering unit 132. Since the IMSI of the mobile phone 110X is already registered in the registering unit 132, the result of the determination made by the determining unit 131 is “OK”.

In this case, next, at step SP4, the ID response message received from the mobile phone 110X is transmitted from the processing unit 130 to the mobile communication network 105. The ID response message includes the IMSI of the mobile phone 110X.

Then, at step SP5, an authentication request message (Authentication Request) is transmitted from the mobile communication network 105 to the mobile phone 110X through the femtocell base station 101F. In addition, an authentication response message (Authentication Response) is transmitted from the mobile phone 110X to the mobile communication network 105 through the femtocell base station 101F. The authentication response message includes an authentication response value generated by the mobile phone 110X based on its IMSI.

Then, at step SP6, authentication as to whether the authentication response value received at step SP5 is a proper one is performed. That is, an authentication response value generated by the mobile communication network 105 itself based on the IMSI received at step SP4 is compared with the authentication response value received at step SP5. If they match, then it is authenticated that the authentication response value received at step SP5 is a proper one. In the case of this example, the authentication response value received at step SP5 is a proper one, and thus, the result of the authentication at step SP6 is “OK”.

Then, at step SP7, a setting information message (Security Mode Command) for setting security mode is transmitted from the mobile communication network 105 to the mobile phone 110X through the femtocell base station 101F. In addition, a security mode setting complete message (Security Mode Complete) is transmitted from the mobile phone 110X to the mobile communication network 105 through the femtocell base station 101F.

Then, at step SP8, a setting message (GUTI Reallocation Command) for reallocating a GUTI is transmitted from the mobile communication network 105 (specifically, the EPC) to the mobile phone 110X through the femtocell base station 101F. In addition, a GUTI reallocation complete message (GUTI Reallocation Complete) is transmitted from the mobile phone 110X to the mobile communication network 105 through the femtocell base station 101F.

Then, at step SP9, an attach accept message (Attach Accept) is transmitted from the mobile communication network 105 to the mobile phone 110X through the femtocell base station 101F. In addition, an attach complete message (Attach Complete) is transmitted from the mobile phone 100X to the mobile communication network 105 through the femtocell base station 101F.

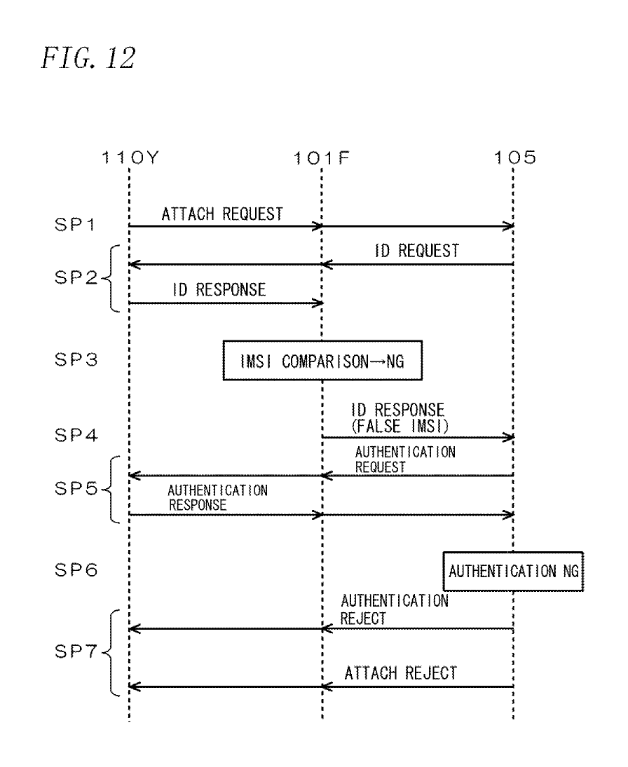

FIG. 12 is a diagram showing a first example of the flow of processes performed when there is an attach request from the mobile phone 110Y which is an unregistered terminal. First, at step SP1, an attach request message is transmitted from the mobile phone 110Y to the mobile communication network 105 (specifically, the MME) through the femtocell base station 101F.

Then, at step SP2, an ID request message for obtaining an IMSI is transmitted from the mobile communication network 105 to the mobile phone 110Y through the femtocell base station 101F. Then, an ID response message is transmitted from the mobile phone 110Y to the femtocell base station 101F. The ID response message includes the IMSI of the mobile phone 110Y.

Then, at step SP3, the determining unit 131 (see FIG. 2) determines whether the IMSI included in the received ID response message matches the IMSI registered in the registering unit 132. Since the IMSI of the mobile phone 110Y is not registered in the registering unit 132, the result of the determination made by the determining unit 131 is “NG”.

In this case, next, at step SP4, an ID response message including a false IMSI is transmitted from the processing unit 130 to the mobile communication network 105. Here, the false IMSI is any value different than the IMSI of the mobile phone 110Y and is generated by the processing unit 130.

Then, at step SP5, an authentication request message is transmitted from the mobile communication network 105 to the mobile phone 110Y through the femtocell base station 101F. In addition, an authentication response message is transmitted from the mobile phone 110Y to the mobile communication network 105 through the femtocell base station 101F. The authentication response message includes an authentication response value generated by the mobile phone 110Y based on its IMSI.

Then, at step SP6, authentication as to whether the authentication response value received at step SP5 is a proper one is performed. That is, an authentication response value generated by the mobile communication network 105 itself based on the IMSI (false IMSI) received at step SP4 is compared with the authentication response value received at step SP5. In the case of this example, they do not match, and thus, the result of the authentication at step SP6 is “NG”.

Then, at step SP7, an authentication reject message (Authentication Reject) and an attach reject message (Attach Reject) are transmitted from the mobile communication network 105 to the mobile phone 110Y through the femtocell base station 101F. Note, however, that in order to avoid the mobile phone 110Y from being processed as an unauthorized terminal, the transmission of an authentication reject message from the femtocell base station 101F to the mobile phone 110Y may be omitted. In addition, as the attach reject cause, a reject cause (Reject Cause No. 15) indicating that the femtocell 103F is not an optimum cell is notified from the mobile communication network 105 to the mobile phone 110Y through the femtocell base station 101F. By this, the mobile phone 110Y searches for an optimum cell other than the femtocell 103F. In the example of FIG. 1, since the mobile phone 110Y is located not only in the femtocell 103F but also in the macrocell 103M, the mobile phone 110Y camps on the macrocell 103M. Note that, for the attach reject cause, a reject cause (Reject Cause No. 25) indicating that the mobile phone 110Y does not belong to a terminal group (CSG: Closed Subscriber Group) that is allowed to access the femtocell base station 101F may be notified from the femtocell base station 101F to the mobile phone 110Y.

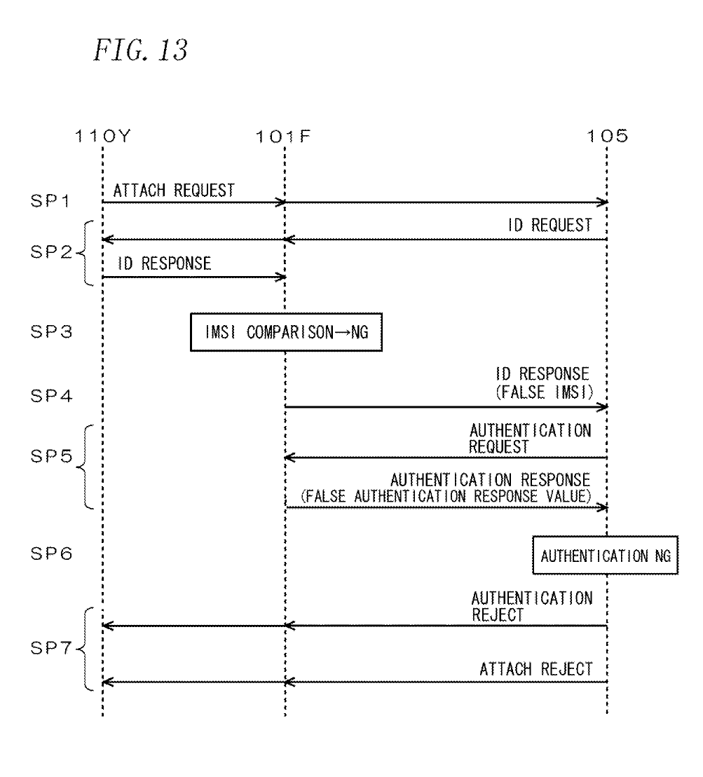

FIG. 13 is a diagram showing a second example of the flow of processes performed when there is an attach request from the mobile phone 110Y which is an unregistered terminal. At step SP5, the transmission and reception of an authentication request message and an authentication response message performed between the femtocell base station 101F and the mobile phone 110Y are omitted. In this case, an authentication response message transmitted from the femtocell base station 101F to the mobile communication network 105 includes a false authentication response value. Here, the false authentication response value is any value different than an authentication response value generated based on the IMSI of the mobile phone 110Y, and is generated by the processing unit 130. Other processes are the same as those in FIG. 12.

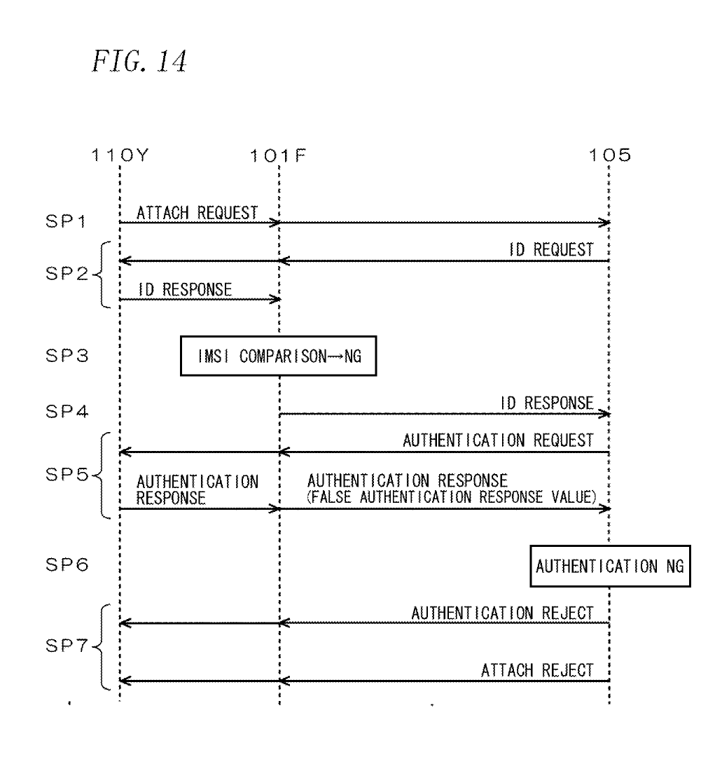

FIG. 14 is a diagram showing a third example of the flow of processes performed when there is an attach request from the mobile phone 110Y which is an unregistered terminal. Those processes before step SP3 are the same as those in FIG. 12.

Then, at step SP4, an ID response message received from the mobile phone 110Y is transmitted from the processing unit 130 to the mobile communication network 105. The ID response message includes the IMSI of the mobile phone 110Y (a proper IMSI but not a false IMSI).

Then, at step SP5, an authentication request message is transmitted from the mobile communication network 105 to the mobile phone 110Y through the femtocell base station 101F. In addition, an authentication response message is transmitted from the mobile phone 110Y to the femtocell base station 101F. The authentication response message includes an authentication response value generated by the mobile phone 110Y based on its IMSI. The processing unit 130 replaces the authentication response value with a different false authentication response value, and then, transmits an authentication response message to the mobile communication network 105. Those processes after step SP6 are the same as those in FIG. 12.

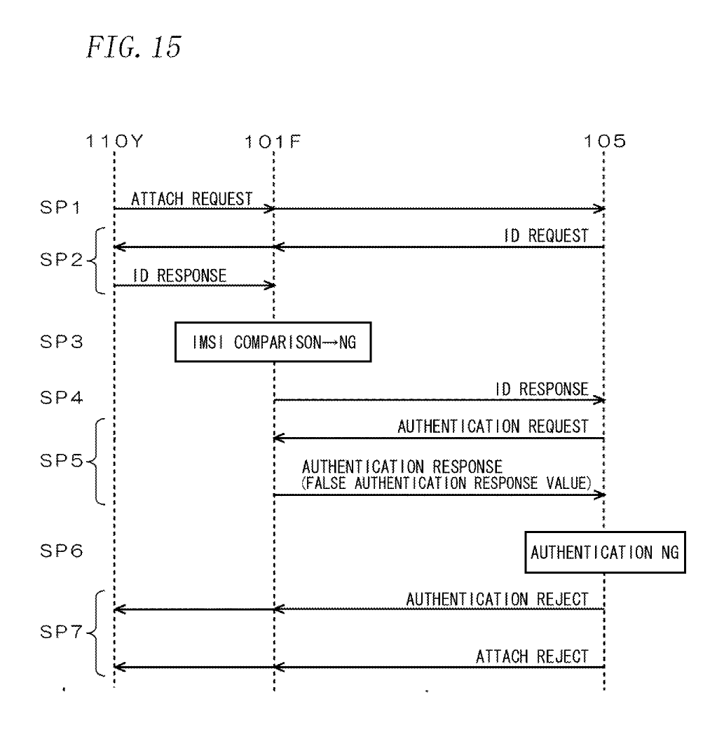

FIG. 15 is a diagram showing a fourth example of the flow of processes performed when there is an attach request from the mobile phone 110Y which is an unregistered terminal. At step SP5, the transmission and reception of an authentication request message and an authentication response message performed between the femtocell base station 101F and the mobile phone 110Y are omitted. In this case, an authentication response message transmitted from the femtocell base station 101F to the mobile communication network 105 includes a false authentication response value. Here, the false authentication response value is any value different than an authentication response value generated based on the IMSI of the mobile phone 110Y, and is generated by the processing unit 130. Other processes are the same as those in FIG. 14.

In the above description, the determining unit 131 compares an IMSI included in an ID response message which is returned from a mobile phone 110 in response to an ID request message transmitted from the mobile communication network 105, with the IMSI registered in the registering unit 132. Meanwhile, in LTE, there may be a case in which the IMSI of the mobile phone 110 may be included in an attach request message. Therefore, in this case, the determining unit 131 can compare the IMSI included in the attach request message, with the IMSI registered in the registering unit 132.

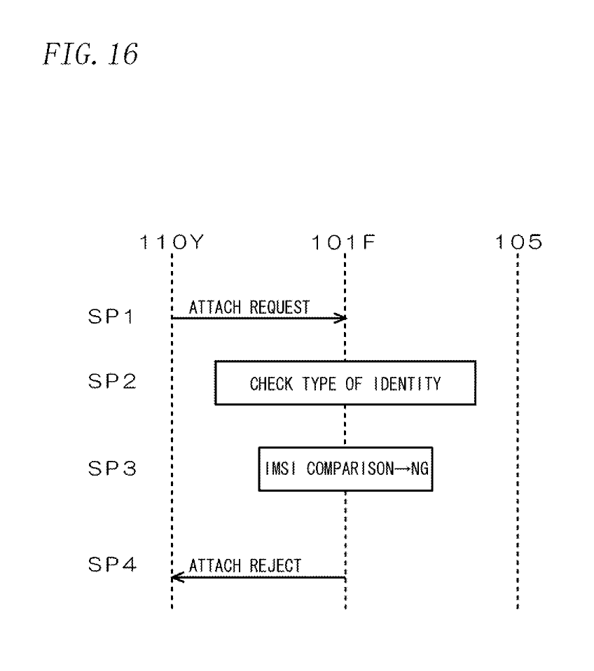

FIG. 16 is a diagram showing a fifth example of the flow of processes performed when there is an attach request from the mobile phone 110Y which is an unregistered terminal. First, at step SP 1, an attach request message is transmitted from the mobile phone 110Y to the femtocell base station 101F.

Then, at step SP2, the processing unit 130 checks a predetermined parameter (specifically, Type of identity in EPS mobile identity IE) in the attach request message. When the value of this parameter is a predetermined value (001), it indicates that the IMSI of the mobile phone 110Y is included in the attach request message.

In this case, next, at step SP3, the determining unit 131 extracts an IMSI from the attach request message and determines whether the IMSI matches the IMSI registered in the registering unit 132. Since the IMSI of the mobile phone 110Y is not registered in the registering unit 132, the result of the determination made by the determining unit 131 is “NG”.

Then, at step SP4, an attach reject message is transmitted from the femtocell base station 101F to the mobile phone 110Y. In addition, as with that described above, as the attach reject cause, a reject cause (Reject Cause No. 15) indicating that the femtocell 103F is not an optimum cell is notified from the femtocell base station 101F to the mobile phone 110Y. By this, the mobile phone 110Y searches for an optimum cell other than the femtocell 103F. In the example of FIG. 1, since the mobile phone 110Y is located not only in the femtocell 103F but also in the macrocell 103M, the mobile phone 110Y camps on the macrocell 103M. Note that, as with that described above, for the attach reject cause, a reject cause (Reject Cause No. 25) indicating that the mobile phone 110Y does not belong to a terminal group that is allowed to access the femtocell base station 101F may be notified from the femtocell base station 101F to the mobile phone 110Y.

Note that, as shown in FIG. 16, the transmission and reception of an ID request message and an ID response message, the transmission and reception of an authentication request message and an authentication response message, and the like, performed between the mobile phone 110Y which is an unregistered terminal and the mobile communication network 105 can be omitted.

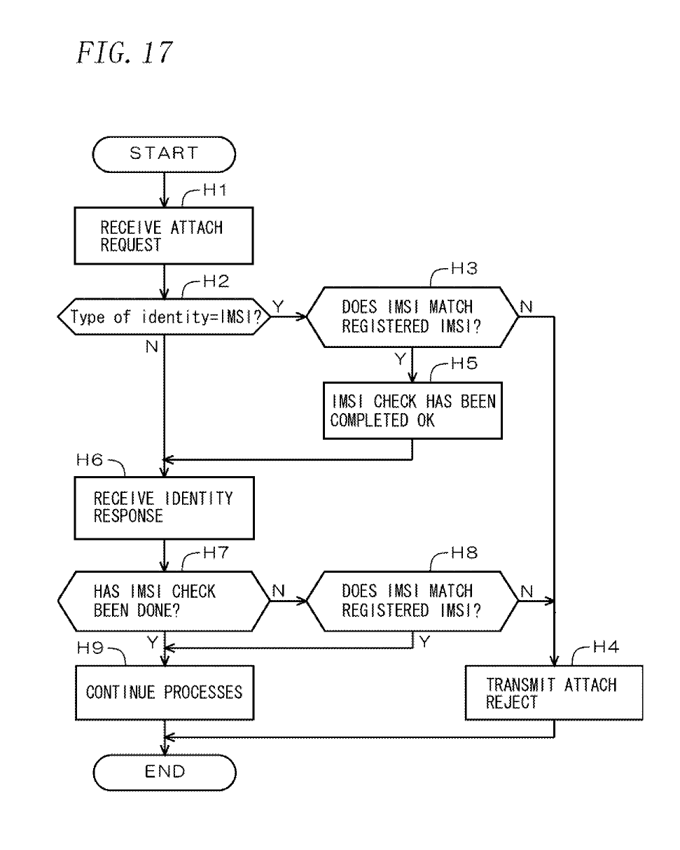

FIG. 17 is a flowchart showing the flow of processes performed when the example shown in FIG. 16 is applied in combination with the examples shown in FIGS. 11 to 15. The flow of processes at steps H1→H2→H3→H4 is the same as the flow of processes at steps SP1→SP2→SP3→SP4 shown in FIG. 16.

If an IMSI is not included in an attach request message (i.e., if the result of determination at step H2 is “NO”), then an attach request message is transmitted from the femtocell base station 101F to the mobile communication network 105, and thereafter, the same processes as those at step SP2 shown in FIGS. 11 to 15 are performed. By this, at step H6, the femtocell base station 101F receives an ID response message from a mobile phone 110.

If an IMSI extracted from the attach request message matches the IMSI registered in the registering unit 132 (i.e., if the result of determination at step H3 is “YES”), then at step 115, the processing unit 130 holds the fact that an IMSI check has been completed (and the result of the check is “OK”) as predetermined flag information. Thereafter, an attach request message is transmitted from the femtocell base station 101F to the mobile communication network 105, and then, the same processes as those at step SP2 shown in FIGS. 11 to 15 are performed. By this, at step H6, the femtocell base station 101F receives an ID response message from the mobile phone 110.

Subsequent to step H6, at step H7, the processing unit 130 determines whether an IMSI check has been completed. This determination is made based on the above-described flag information. If an IMSI check has not been completed then processing proceeds to step H8, and if completed then processing proceeds to step H9. If the result of determination at step H2 is “NO”, then processing proceeds in the order of steps H6→H7→H8. In addition, if the result of determination at step H3 is “YES”, then processing proceeds in the order of steps H5→H6→H7→H9.

At step H8, the same process as that at step SP3 shown in FIGS. 11 to 15 is performed. That is, the determining unit 131 determines whether an IMSI included in the ID response message received at step H6 matches the IMSI registered in the registering unit 132. If the result of the determination at step H8 is “YES”, then next, at step H9, those processes after step SP4 shown in FIG. 11 are performed. On the other hand, if the result of the determination at step H8 is “NO”, then next, at step H4, those processes after step SP4 shown in FIGS. 12 to 15 are performed.

As such, according to the femtocell base station 101F according to the first embodiment, the IMSI of a mobile phone 110 that is allowed to access the femtocell base station 101F (i.e., the mobile phone 110X) is registered in advance in the registering unit 132. In addition, the determining unit 131 determines whether the IMSI of a mobile phone 110 accessing the femtocell base station 101F is registered in the registering unit 132, and thereby determines whether the mobile phone 110 is a registered terminal or an unregistered terminal. If the mobile phone 110 accessing the femtocell base station 101F is determined by the determining unit 131 to be an unregistered terminal, then access by the mobile phone 110 (i.e., the mobile phone 110Y) to the femtocell base station 101F is limited. As a result, the mobile phone 110Y of a third person is avoided from being connected to the femtocell base station 101F, securing the number of mobile phones 110 accommodated, with which the femtocell base station 101F can perform simultaneous communications. Thus, an authorized user can reliably perform communication via the femtocell base station 101F.

In addition, according to the femtocell base station 101F according to the first embodiment, the processing unit 130 performs a process for registering an IMSI received from the mobile phone 110X in a predetermined apparatus (HLR or MME) in the mobile communication network 105. By registering the IMSI, the mobile phone 110X can perform communication via the femtocell base station 101F. On the other hand, the processing unit 130 performs a process for not registering an IMSI received from the mobile phone 110Y in the predetermined apparatus (HLR or MME) in the mobile communication network 105. By not registering the IMSI, the mobile phone 110Y can be avoided from performing communication via the femtocell base station 101F.

In addition, as shown in FIGS. 5, 6, 12, and 13, according to the femtocell base station 101F according to the first embodiment, the processing unit 130 transmits, as the IMSI of the mobile phone 110Y, a false IMSI different than the IMSI of the mobile phone 110Y to the mobile communication network 105, in response to an ID request message transmitted from the mobile communication network 105 to the mobile phone 110Y. By this, in a subsequent authentication process, the result of authentication of the mobile phone 110Y is NG, and thus, the registration of the mobile phone 110Y in the HLR or MME can be rejected.

In addition, as shown in FIGS. 6 to 8 and 13 to 15, according to the femtocell base station 101F according to the first embodiment, the processing unit 130 transmits, as an authentication response value of the mobile phone 110Y, a false authentication response value different than an authentication response value transmitted from the mobile phone 110Y, to the mobile communication network 105 in response to an authentication request message transmitted from the mobile communication network 105 to the mobile phone 110Y. By this, the result of authentication of the mobile phone 110Y is NG, and thus, the registration of the mobile phone 110Y in the HLR or MME can be rejected.

In addition, as shown in FIGS. 6, 8, 13, and 15, according to the femtocell base station 101F according to the first embodiment, the processing unit 130 omits the transmission of an authentication request message to the mobile phone 110Y. Since it is known that the result of authentication of the mobile phone 110Y is NG, there is no particular inconvenience in not transmitting an authentication request message to the mobile phone 110Y. By omitting the transmission of an authentication request message to the mobile phone 110Y (and the reception of an authentication response value in response thereto), a reduction in the amount of data communicated between the femtocell base station 101F and the mobile phone 110Y can be achieved.

In addition, according to the femtocell base station 101F according to the first embodiment, when the registration of the mobile phone 110Y in the HLR or MME is rejected, a location registration reject message or attach reject message with a reject cause indicating that the femtocell 103F is not an optimum cell is transmitted to the mobile phone 110Y. Hence, the mobile phone 110Y having received these reject messages searches for an optimum cell other than the femtocell 103F. Accordingly, when the mobile phone 110Y is also located in a cell (e.g., the macrocell 103M) other than the femtocell 103F, the mobile phone 110Y identifies the macrocell 103M as an optimum cell and can perform communication via the macrocell base station 101M.

In addition, according to the femtocell base station 101F according to the first embodiment, when the registration of the mobile phone 110Y in the HLR or MME is rejected, a location registration reject message or attach reject message with a reject cause indicating that the mobile phone 110Y does not belong to a terminal group (CSG) that is allowed to access the femtocell base station 101F is transmitted to the mobile phone 110Y. Hence, the mobile phone 110Y having received these reject messages gives up access to the femtocell base station 101F and starts searching for a cell other than the femtocell 103F. Accordingly, when the mobile phone 110Y is also located in a cell (e.g., the macrocell 103M) other than the femtocell 103F, the mobile phone 110Y identifies the macrocell 103M as an optimum cell and can perform communication via the macrocell base station 101M.

In addition, as shown in FIGS. 9, 10, 16, and 17, according to the femtocell base station 101F according to the first embodiment, when an IMSI is included in a location registration request message (tracking area update request message) or an attach request message, the determining unit 131 determines based on the IMSI whether the mobile phone 110 is a registered terminal or an unregistered terminal. If, as a result of the determination, the mobile phone 110 is an unregistered terminal, then there is no need to perform transmission and reception of an ID request message and a response message thereto and an authentication request message and a response message thereto between the mobile communication network 105 and the mobile phone 110Y. As a result, a reduction in the amount of data communicated can be achieved.

In addition, according to the femtocell base station 101F according to the first embodiment, by using an IMSI unique to each mobile phone 110 as unique identification information, the determining unit 131 can make an accurate determination between a registered terminal and an unregistered terminal.

### Second Embodiment

Although the above-described first embodiment describes a femtocell base station 101F that supports LTE, the present invention can also be applied to a femtocell base station 101F that supports W-CDMA (Wideband Code Division Multiple Access).

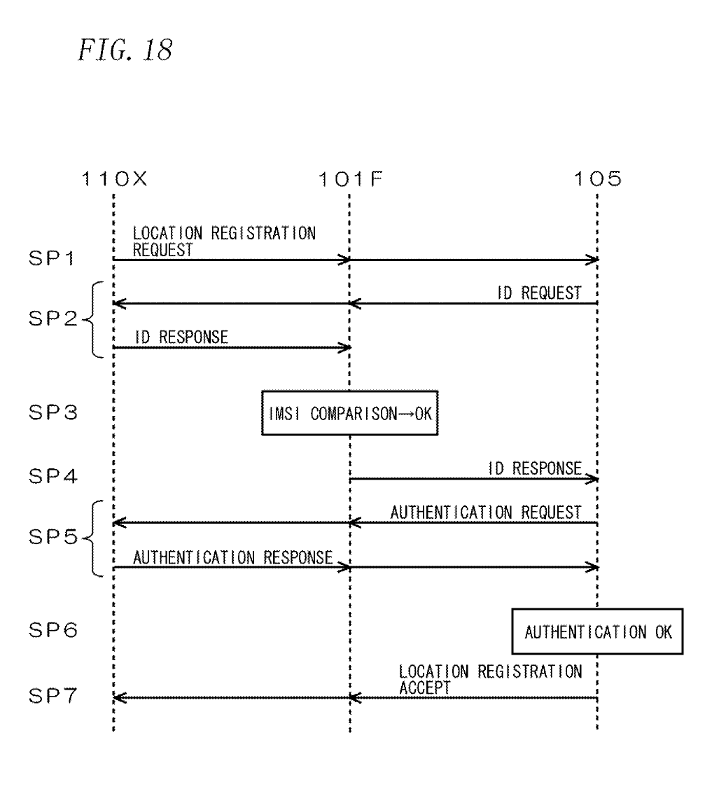

FIG. 18 is a diagram simply showing the flow of processes performed when there is a location registration request for a circuit switching domain (CS domain) from a mobile phone 110X which is a registered terminal. First, at step SP1, a location registration request message (Location Updating Request) is transmitted from the mobile phone 110X to a mobile communication network 105 (specifically, an HLR) through the femtocell base station 101F.

Then, at step SP2, an ID request message (Identity Request) for obtaining an IMSI is transmitted from the mobile communication network 105 to the mobile phone 110X through the femtocell base station 101F. Then, an ID response message (Identity Response) is transmitted from the mobile phone 110X to the femtocell base station 101F. The ID response message includes the IMSI of the mobile phone 110X.

Then, at step SP3, a determining unit 131 (see FIG. 2) determines whether the IMSI included in the received ID response message matches an IMSI registered in a registering unit 132. Since the IMSI of the mobile phone 110X is already registered in the registering unit 132, the result of the determination made by the determining unit 131 is “OK”.

In this case, next, at step SP4, the ID response message received from the mobile phone 110X is transmitted from a processing unit 130 to the mobile communication network 105. The ID response message includes the IMSI of the mobile phone 110X.

Then, at step SP5, an authentication request message (Authentication Request) is transmitted from the mobile communication network 105 to the mobile phone 110X through the femtocell base station 101F. In addition, an authentication response message (Authentication Response) is transmitted from the mobile phone 110X to the mobile communication network 105 through the femtocell base station 101F. The authentication response message includes an authentication response value generated by the mobile phone 110X based on its IMSI.

Then, at step SP6, authentication as to whether the authentication response value received at step SP5 is a proper one is performed. That is, an authentication response value generated by the mobile communication network 105 itself based on the IMSI received at step SP4 is compared with the authentication response value received at step SP5. If they match, then it is authenticated that the authentication response value received at step SP5 is a proper one. In the case of this example, the authentication response value received at step SP5 is a proper one, and thus, the result of the authentication at step SP6 is “OK”.

Then, at step SP7, a location registration accept message (Location Updating Accept) is transmitted from the mobile communication network 105 to the mobile phone 110X through the femtocell base station 101F.

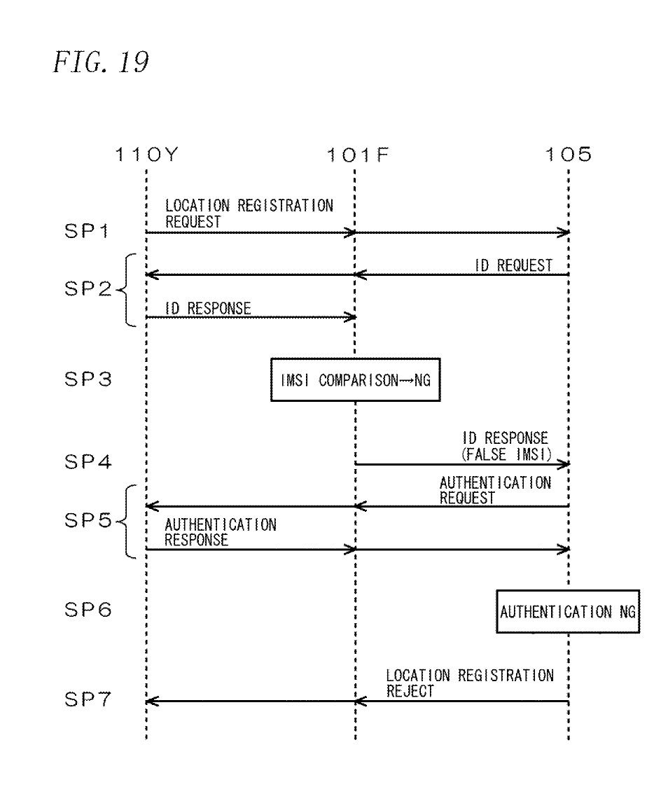

FIG. 19 is a diagram showing the flow of processes performed when there is a location registration request for the CS domain from a mobile phone 110Y which is an unregistered terminal. First, at step SP1, a location registration request message is transmitted from the mobile phone 110Y to the mobile communication network 105 (specifically, the HLR) through the femtocell base station 101F.

Then, at step SP2, an ID request message for obtaining an IMSI is transmitted from the mobile communication network 105 to the mobile phone 110Y through the femtocell base station 101F. Then, an ID response message is transmitted from the mobile phone 110Y to the femtocell base station 101F. The ID response message includes the IMSI of the mobile phone 110Y.

Then, at step SP3, the determining unit 131 (see FIG. 2) determines whether the IMSI included in the received ID response message matches the IMSI registered in the registering unit 132. Since the IMSI of the mobile phone 110Y is not registered in the registering unit 132, the result of the determination made by the determining unit 131 is “NG”.

In this case, next, at step SP4, an ID response message including a false IMSI is transmitted from the processing unit 130 to the mobile communication network 105. Here, the false IMSI is any value different than the IMSI of the mobile phone 110Y and is generated by the processing unit 130.

Then, at step SP5, an authentication request message is transmitted from the mobile communication network 105 to the mobile phone 110Y through the femtocell base station 101F. In addition, an authentication response message is transmitted from the mobile phone 110Y to the mobile communication network 105 through the femtocell base station 101F. The authentication response message includes an authentication response value generated by the mobile phone 110Y based on its IMSI.

Then, at step SP6, authentication as to whether the authentication response value received at step SP5 is a proper one is performed. That is, an authentication response value generated by the mobile communication network 105 itself based on the IMSI (false IMSI) received at step SP4 is compared with the authentication response value received at step SP5. In the case of this example, they do not match, and thus, the result of the authentication at step SP6 is “NG”.

Then, at step SP7, a location registration reject message (Location Updating Reject) is transmitted from the mobile communication network 105 to the mobile phone 110Y through the femtocell base station 101F. Note that, as with the above-described first embodiment, as the location registration reject cause, a reject cause (Reject Cause No. 15) indicating that the femtocell 103F is not an optimum cell is notified from the femtocell base station 101F to the mobile phone 110Y. By this, the mobile phone 110Y searches for an optimum cell other than the femtocell 103F. In the example of FIG. 1, since the mobile phone 110Y is located not only in the femtocell 103F but also in the macrocell 103M, the mobile phone 110Y camps on the macrocell 103M. In addition, as with that described above, for the location registration reject cause, a reject cause (Reject Cause No. 25) indicating that the mobile phone 110Y does not belong to a terminal group that is allowed to access the femtocell base station 101F may be notified from the femtocell base station 101F to the mobile phone 110Y.

Note that, when there is an attach request (Attach Request) for the CS domain from a mobile phone 110, too, the attach request can be processed in the same manner as in FIGS. 18 and 19. In the attach request, the IMSI of the mobile phone 110X is registered in an MSC (Mobile Services Switching Center) instead of in the HLR.

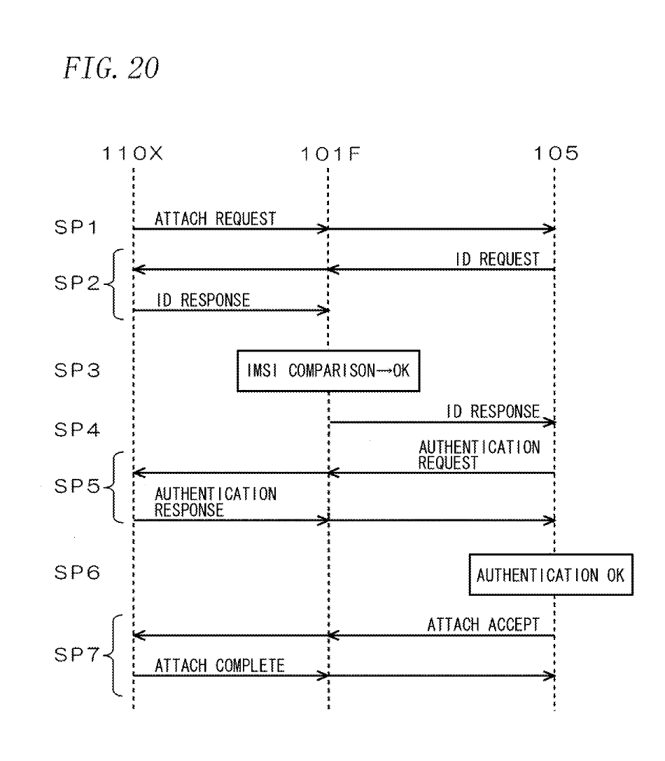

FIG. 20 is a diagram simply showing the flow of processes performed when there is an attach request for a packet switching domain (PS domain) from the mobile phone 110X which is a registered terminal. First, at step SP1, an attach request message (Attach Request) is transmitted from the mobile phone 110X to the mobile communication network 105 (specifically, an SGSN: Serving GPRS Support Node) through the femtocell base station 101F.

Then, at step SP2, an ID request message (Identity Request) for obtaining an IMSI is transmitted from the mobile communication network 105 to the mobile phone 110X through the femtocell base station 101F. Then, an ID response message (Identity Response) is transmitted from the mobile phone 110X to the femtocell base station 101F. The ID response message includes the IMSI of the mobile phone 110X.

Then, at step SP3, the determining unit 131 (see FIG. 2) determines whether the IMSI included in the received ID response message matches the IMSI registered in the registering unit 132. Since the IMSI of the mobile phone 110X is already registered in the registering unit 132, the result of the determination made by the determining unit 131 is “OK”.

In this case, next, at step SP4, the ID response message received from the mobile phone 110X is transmitted from the processing unit 130 to the mobile communication network 105. The ID response message includes the IMSI of the mobile phone 110X.

Then, at step SP5, an authentication request message (Authentication Request) is transmitted from the mobile communication network 105 to the mobile phone 110X through the femtocell base station 101F. In addition, an authentication response message (Authentication Response) is transmitted from the mobile phone 110X to the mobile communication network 105 through the femtocell base station 101F. The authentication response message includes an authentication response value generated by the mobile phone 110X based on its IMSI.

Then, at step SP6, authentication as to whether the authentication response value received at step SP5 is a proper one is performed. That is, an authentication response value generated by the mobile communication network 105 itself based on the IMSI received at step SP4 is compared with the authentication response value received at step SP5. If they match, then it is authenticated that the authentication response value received at step SP5 is a proper one. In the case of this example, the authentication response value received at step SP5 is a proper one, and thus, the result of the authentication at step SP6 is “OK”.

Then, at step SP7, an attach accept message (Attach Accept) is transmitted from the mobile communication network 105 to the mobile phone 110X through the femtocell base station 101F. In addition, an attach complete message (Attach Complete) is transmitted from the mobile phone 100X to the mobile communication network 105 through the femtocell base station 101F.

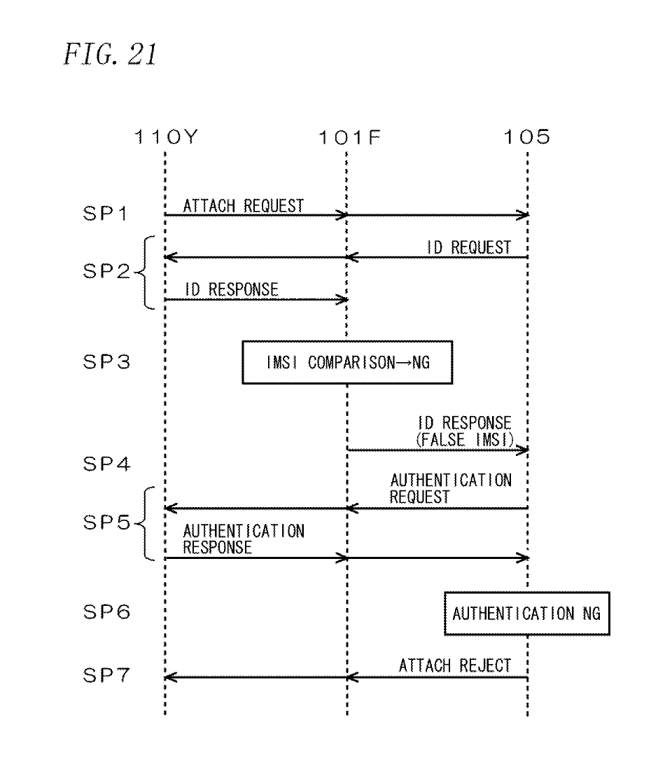

FIG. 21 is a diagram showing the flow of processes performed when there is an attach request for the PS domain from the mobile phone 110Y which is an unregistered terminal. First, at step SP1, an attach request message is transmitted from the mobile phone 110Y to the mobile communication network 105 (specifically, the SGSN) through the femtocell base station 101F.

Then, at step SP2, an ID request message for obtaining an IMSI is transmitted from the mobile communication network 105 to the mobile phone 110Y through the femtocell base station 101F. Then, an ID response message is transmitted from the mobile phone 110Y to the femtocell base station 101F. The ID response message includes the IMSI of the mobile phone 110Y.

Then, at step SP3, the determining unit 131 (see FIG. 2) determines whether the IMSI included in the received ID response message matches the IMSI registered in the registering unit 132. Since the IMSI of the mobile phone 110Y is not registered in the registering unit 132, the result of the determination made by the determining unit 131 is “NG”.

In this case, next, at step SP4, an ID response message including a false IMSI is transmitted from the processing unit 130 to the mobile communication network 105. Here, the false IMSI is any value different than the IMSI of the mobile phone 110Y and is generated by the processing unit 130.

Then, at step SP5, an authentication request message is transmitted from the mobile communication network 105 to the mobile phone 110Y through the femtocell base station 101F. In addition, an authentication response message is transmitted from the mobile phone 110Y to the mobile communication network 105 through the femtocell base station 101F. The authentication response message includes an authentication response value generated by the mobile phone 110Y based on its IMSI.

Then, at step SP6, authentication as to whether the authentication response value received at step SP5 is a proper one is performed. That is, an authentication response value generated by the mobile communication network 105 itself based on the IMSI (false IMSI) received at step SP4 is compared with the authentication response value received at step SP5. In the case of this example, they do not match, and thus, the result of the authentication at step SP6 is “NG”.

Then, at step SP7, an attach reject message (Attach Reject) is transmitted from the mobile communication network 105 to the mobile phone 110Y through the femtocell base station 101F. Note that, as with that described above, as the attach reject cause, a reject cause (Reject Cause No. 15) indicating that the femtocell 103F is not an optimum cell is notified from the femtocell base station 101F to the mobile phone 110Y. Note also that, as that described above, a reject cause (Reject Cause No. 25) indicating that the mobile phone 110Y does not belong to a terminal group that is allowed to access the femtocell base station 101F may be notified from the femtocell base station 101F to the mobile phone 110Y.

Note that, when there is a location registration request (Routing Area Updating Request) for the PS domain from a mobile phone 110, too, the location registration request can be processed in the same manner as in FIGS. 20 and 21. In the location registration request, the IMSI of the mobile phone 110X is registered in the HLR instead of in the SGSN.

Although FIGS. 19 and 21 show processing sequences for the example shown in FIG. 5, in the second embodiment, too, the processing sequences shown in FIGS. 6 to 10 can be employed.

### Third Embodiment

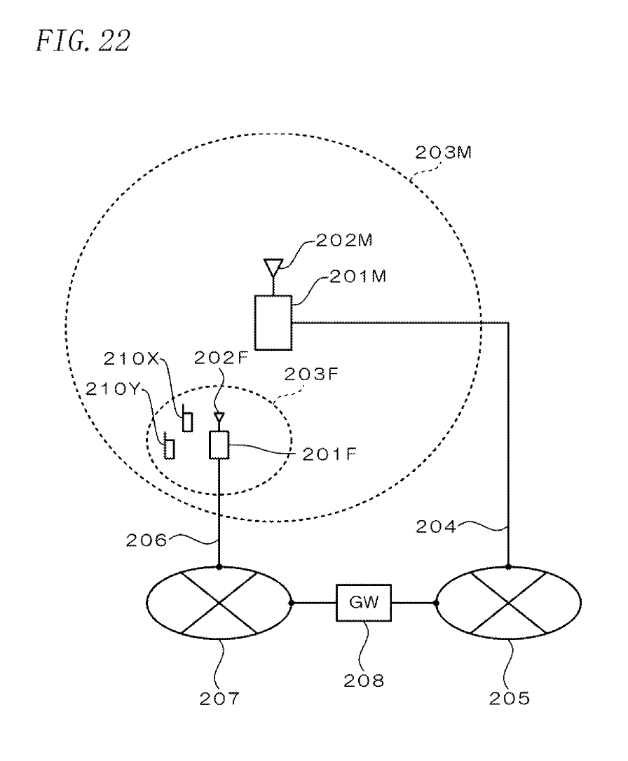

FIG. 22 is a diagram schematically showing an overall configuration of a communication system according to a third embodiment of the present invention. A small-size base station 201F is installed in, for example, a user's home. The small-size base station 201F has, as its coverage area, a very small cell with a radius of the order of several meters to several tens of meters. In addition, in the small-size base station 201F, the number of mobile phones that can simultaneously perform communication (the number of mobile phones accommodated) is limited to about several mobile phones (e.g., eight mobile phones). In this specification, the coverage area of the small-size base station is hereinafter referred to as the “femtocell” and the small-size base station is hereinafter referred to as the “femtocell base station”. Referring to FIG. 22, a femtocell 203F which is a coverage area of the femtocell base station 201F is provided around the femtocell base station 201F. A macrocell base station 201M is installed, for example, outdoors. A macrocell 203M which is a coverage area of the macrocell base station 201M is provided around the macrocell base station 201M.

In the example shown in FIG. 22, the femtocell 203F is included in the macrocell 203M. Therefore, mobile phones 210 (denoted by reference numerals 210X and 210Y in FIG. 22) located within the femtocell 203F can perform transmission and reception of radio waves with an antenna 202F of the femtocell base station 201F, and can also perform transmission and reception of radio waves with an antenna 202M of the macrocell base station 201M. In the following description, it is assumed that the mobile phone 210X is a mobile phone owned by an authorized user of the femtocell base station 201F, and the mobile phone 210Y is a mobile phone owned by a third person who is not an authorized user of the femtocell base station 201F.

The macrocell base station 201M is connected to a mobile communication network 205 of a mobile service provider through a communication line 204. The femtocell base station 201F is connected to an IP (Internet Protocol) network 207 through a wire communication line 206 such as an optical fiber or a metal cable. The IP network 207 is connected to the mobile communication network 205 through a gateway 208.

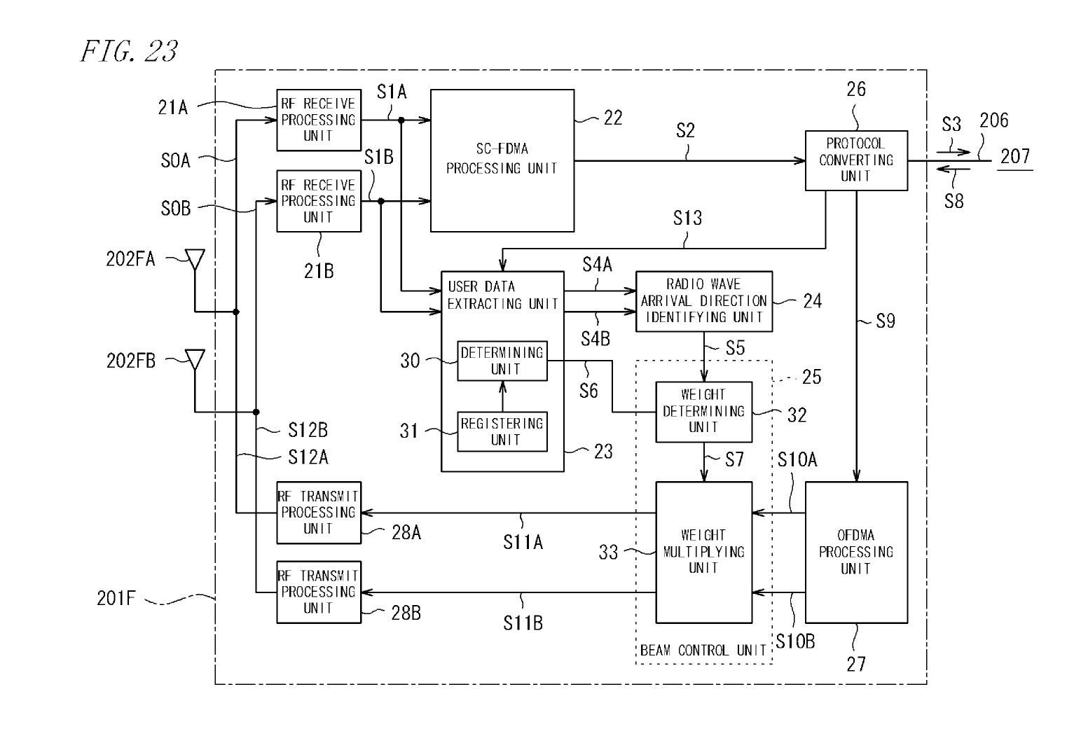

FIG. 23 is a block diagram showing a configuration of the femtocell base station 201F. The femtocell base station 201F is a base station that supports LTE (Long Term Evolution). In LTE, OFDMA (Orthogonal Frequency Division Multiple Access) is employed as a downlink wireless access scheme, and SC-FDMA (Single Carrier-Frequency Division Multiple Access) is employed as an uplink wireless access scheme.

The femtocell base station 201F is configured to include an array antenna having a plurality of antenna elements, as the antenna 202F shown in FIG. 22. In the example shown in FIG. 23, the antenna 202F has two antenna elements 202FA and 202FB. Note, however, that the number of antenna elements may be three or more. In LTE, normally, four antenna elements are provided.

In addition, as shown in a connection relation in FIG. 23, the femtocell base station 201F is configured to include RF (Radio Frequency) receive processing units 21A and 21B, an SC-FDMA processing unit 22, a user data extracting unit 23, a radio wave arrival direction identifying unit 24, a beam control unit 25, a protocol converting unit 26, an OFDMA processing unit 27, and RF transmit processing units 28A and 28B. The user data extracting unit 23 includes a determining unit 30 and a registering unit 31. The beam control unit 25 includes a weight determining unit 32 and a weight multiplying unit 33.

The RF receive processing unit 21A performs predetermined receive processes, such as frequency conversion and AD (Analog-to-Digital) conversion, on a signal SOA received by the antenna element 202FA. Likewise, the RF receive processing unit 21B performs predetermined receive processes on a signal SOB received by the antenna element 202FB.

The SC-FDMA processing unit 22 performs a normal SC-FDMA receive process based on signals S1A and S1B inputted from the RF receive processing units 21A and 21B.

The protocol converting unit 26 converts a signal S2 of a protocol supported by mobile phones which is inputted from the SC-FDMA processing unit 22 into a signal S3 of a protocol supported by the IP network 207. The signal S3 is transmitted towards the mobile communication network 205. In addition, the protocol converting unit 26 converts a signal S8 of a protocol supported by the IP network 207 which is received from the mobile communication network 205 into a signal S9 of a protocol supported by mobile phones.

The OFDMA processing unit 27 performs a normal OFDMA transmit process based on the signal S9 inputted from the protocol converting unit 26. From the OFDMA processing unit 27 are outputted a signal S10A to be transmitted from the antenna element 202FA and a signal S10B to be transmitted from the antenna element 202FB.

The RF transmit processing unit 28A performs predetermined transmit processes, such as DA (Digital-to-Analog) conversion and frequency conversion, on a signal S11A inputted from the beam control unit 25. Likewise, the RF transmit processing unit 28B performs predetermined transmit processes on a signal S11B inputted from the beam control unit 25.

A signal S13 regarding UE (User Equipment) information of a mobile phone 210 is inputted to the user data extracting unit 23 from the protocol converting unit 26. The user data extracting unit 23 identifies frequency-time resources allocated to the mobile phone 210, based on the signal S13. That is, a user data location for the mobile phone 210 in a radio frame is identified.

In addition, to the user data extracting unit 23 are inputted the signals S1A and S1B from the RF receive processing units 21A and 21B, respectively. The user data extracting unit 23 extracts user data whose location is identified based on the signal S13, from the signals S1A and S1B. That is, user data for the mobile phone 210 is extracted from radio frames of the signals S1A and S1B. User data extracted from the signal S1A is inputted to the radio wave arrival direction identifying unit 24, as a signal S4A. In addition, user data extracted from the signal S1B is inputted to the radio wave arrival direction identifying unit 24, as a signal S4B.

The registering unit 31 registers in advance the IMSI (International Mobile Subscriber Identity) of a mobile phone 210 that is allowed to access the femtocell base station 201F (in this example, the mobile phone 210X). Any method can be employed for registering the IMSI in the registering unit 31. For example, the IMSI can be registered when the femtocell base station 201F is purchased, by using a dedicated terminal at the purchasing store. Alternatively, the IMSI can also be registered via the Internet using dedicated application software, after installing the femtocell base station 201F in a home. Alternatively, the IMSI of the mobile phone 210X can also be registered by connecting the mobile phone 210X to the femtocell base station 201F by wire or wireless.

The determining unit 30 compares an IMSI extracted from the signal S1A or the signal S1B with the IMSI registered in the registering unit 31. If the IMSI extracted from the signal S1A or the signal S1B matches the IMSI registered in the registering unit 31, then the determining unit 30 determines that the mobile phone 210 is a registered terminal (i.e., the mobile phone 210X owned by an authorized user). On the other hand, if the IMSI extracted from the signal S1A or the signal S1B does not match the IMSI registered in the registering unit 31, then the determining unit 30 determines that the mobile phone 210 is an unregistered terminal (i.e., the mobile phone 210Y owned by a third person). The result of the determination made by the determining unit 30 is outputted as a signal S6.

The radio wave arrival direction identifying unit 24 identifies a direction of arrival (DOA: Direction Of Arrival) of radio waves from the mobile phone 210 based on the signals S4A and S4B, by any radio wave arrival direction estimation algorithm which uses the phase difference or signal strength difference between the signals S4A and S4B. That is, the direction in which the mobile phone 210 is located with reference to the femtocell base station 201F is identified. The direction of arrival of radio waves from the mobile phone 210 identified by the radio wave arrival direction identifying unit 24 is outputted as a signal S5.

The beam control unit 25 controls the directivity of the antenna 202F based on the signals S5 and S6. Specifically, when a registered terminal (the mobile phone 210X) is located in a direction given by the signal S5, the weight determining unit 32 determines a weight that allows a peak of a transmit beam from the antenna 202F (the point at which the beam intensity is highest) to be steered in the direction. On the other hand, when an unregistered terminal (the mobile phone 210Y) is located in the direction given by the signal S5, the weight determining unit 32 determines a weight that allows a null of a transmit beam from the antenna 202F (the point at which the beam intensity is lowest) to be steered in the direction. The weights determined by the weight determining unit 32 are inputted to the weight multiplying unit 33, as signals S7. The weight multiplying unit 33 multiplies the signals S10A and S10B by the weights determined by the weight determining unit 32, and thereby outputs the signals S11A and S11B.

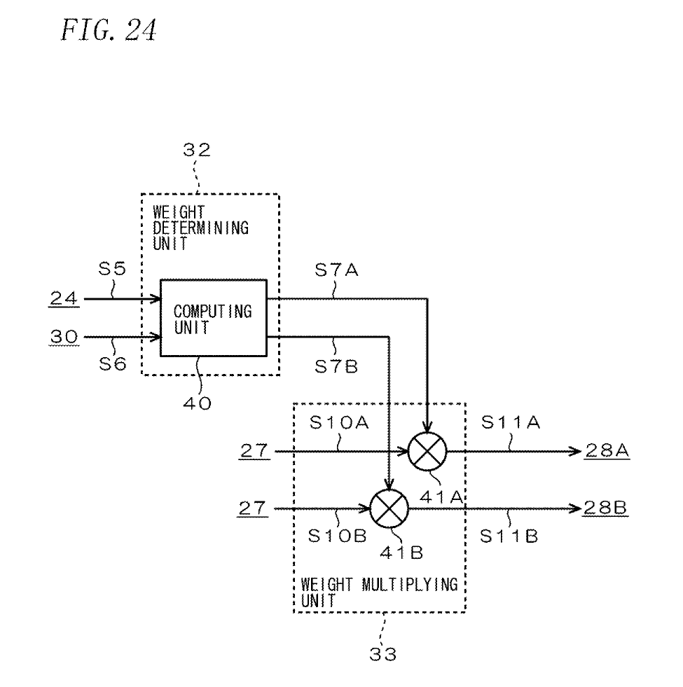

FIG. 24 is a block diagram showing a first exemplary configuration of the weight determining unit 32 and the weight multiplying unit 33. The weight determining unit 32 includes a computing unit 40. The computing unit 40 determines, by computations, a weight by which a signal S10A is multiplied and a weight by which a signal S10B is multiplied, based on signals S5 and S6. The weight by which the signal S10A is multiplied is outputted as a signal S7A, and the weight by which the signal S10B is multiplied is outputted as a signal S7B.

The weight multiplying unit 33 includes multipliers 41A and 41B. The multiplier 41A multiplies the signal S10A and the signal S7A and thereby outputs a signal S11A. The multiplier 41B multiplies the signal S10B and the signal S7B and thereby outputs a signal S11B.

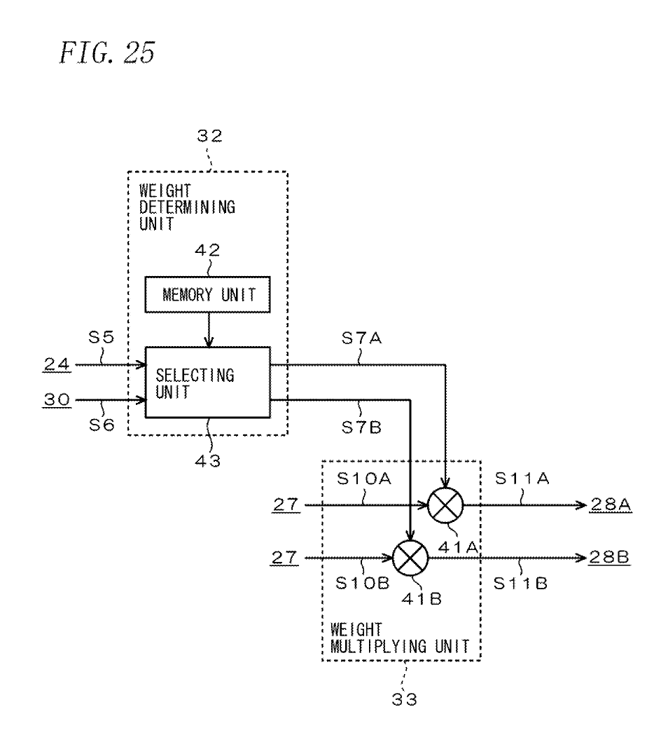

FIG. 25 is a block diagram showing a second exemplary configuration of the weight determining unit 32 and the weight multiplying unit 33. The weight determining unit 32 includes a memory unit 42 and a selecting unit 43. The memory unit 42 memorizes in advance a plurality of patterns regarding weights by which outputs from the respective antenna elements 202FA and 202FB are multiplied, assuming various combinations of the numbers of registered terminals or unregistered terminals and the directions in which the terminals are located. The selecting unit 43 selects, based on signals S5 and S6, optimum weights from among the plurality of patterns memorized in the memory unit 42. A weight by which a signal S10A is multiplied is outputted as a signal S7A, and a weight by which a signal S10B is multiplied is outputted as a signal S7B. The configuration of the weight multiplying unit 33 is the same as that in FIG. 24.

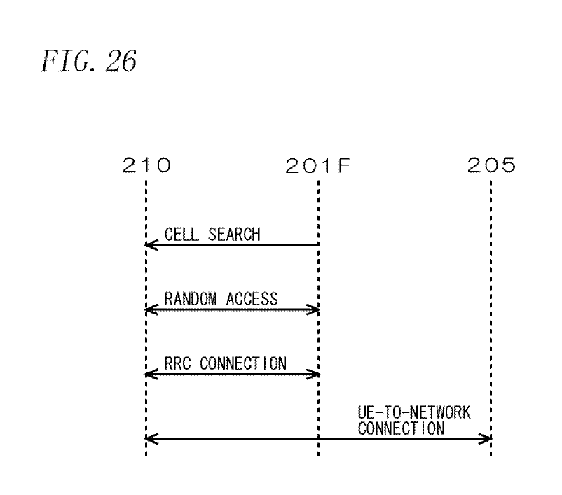

FIG. 26 is a diagram schematically showing the flow of a connection process in LTE. First, by a cell search, processes such as carrier wave frequency synchronization, radio frame synchronization, and cell ID identification are performed. Thereafter, system information such as a Master Information Block (MIB) and System Information Blocks (SIBs) is transmitted from the femtocell base station 201F to a mobile phone 210. In addition, by a peripheral cell search, a more optimum cell search is periodically performed.

Then, by random access, a correction to the transmission timing is made. Specifically, the mobile phone 210 generates a unique preamble sequence based on the SIBs received from the femtocell base station 201F, and transmits the preamble sequence towards the femtocell base station 201F. The femtocell base station 201F calculates a correction value of the transmission timing based on the received preamble sequence, and transmits the correction value to the mobile phone 210. The mobile phone 210 corrects the transmission timing based on the received correction value. In addition, a CR-ID (Contention Resolution-IDentifier) for performing contention determination is transmitted from the mobile phone 210 to the femtocell base station 201F. When the femtocell base station 201F receives the CR-ID normally, the femtocell base station 201F returns the CR-ID to the mobile phone 210 and transmits a unique ID (C-RNTI: Cell-Radio Network Temporary Identifier) for identifying the mobile phone 210 within the cell, to the mobile phone 210.

Then, by RRC (Radio Resource Control) connection, bearer establishment and radio resource allocation are performed. Specifically, first, an RRC connection request signal is transmitted from the mobile phone 210 to the femtocell base station 201F. The femtocell base station 201F having received the RRC connection request signal transmits setting information for establishing a control signal bearer (SRB1), to the mobile phone 210. When the mobile phone 210 has completed the establishment of a control signal bearer (SRB1), the mobile phone 210 transmits a setting complete signal to the femtocell base station 201F. Thereafter, the femtocell base station 201F transmits setting information for setting security mode, to the mobile phone 210. When the mobile phone 210 has completed the setting of security mode, the mobile phone 210 transmits a setting complete signal to the femtocell base station 201F. Then, the femtocell base station 201F transmits setting information for establishing a control signal bearer (SRB2) and a data signal bearer (DRB), to the mobile phone 210. When the mobile phone 210 has completed the establishment of a control signal bearer (SRB2) and a data signal bearer, the mobile phone 210 transmits a setting complete signal to the femtocell base station 201F.

Then, a connection between the mobile phone 210 and the mobile communication network 205 (a UE-to-network connection) is established. The UE-to-network connection includes processes such as location registration (i.e., a tracking area update), attach, call connection, and call release.

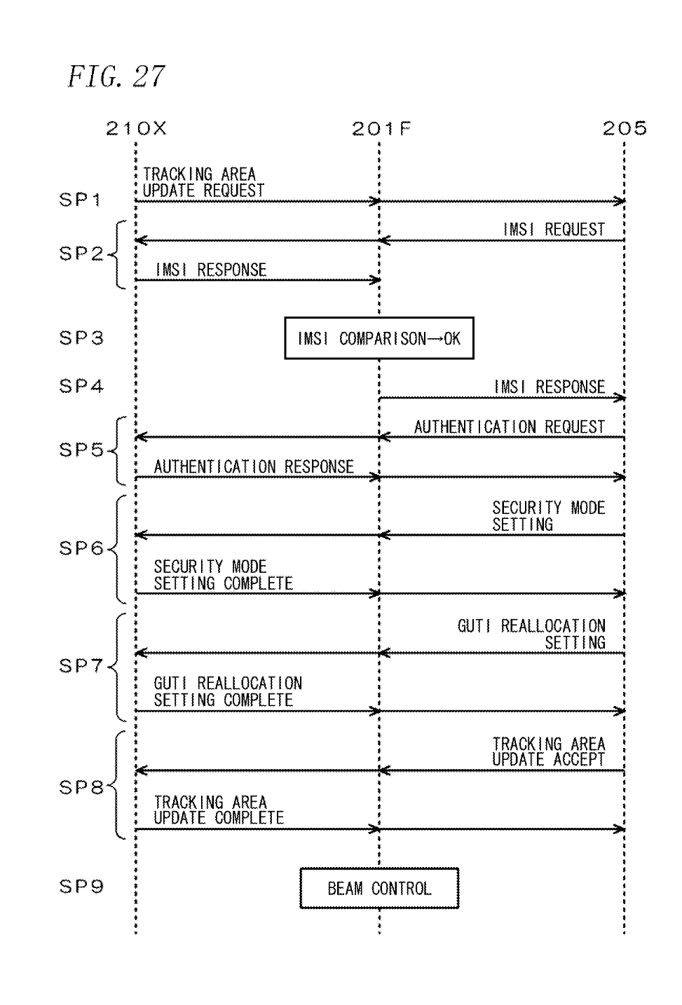

FIG. 27 is a diagram showing the flow of processes performed when there is a location registration request from the mobile phone 210X which is a registered terminal. First, at step SP1, a tracking area update request signal (Tracking Area Update Request) is transmitted from the mobile phone 210X to the mobile communication network 205 (specifically, an HLR (Home Location Register)) through the femtocell base station 201F.

Then, at step SP2, an ID request signal (Identity Request) for obtaining an IMSI is transmitted from the mobile communication network 205 to the mobile phone 210X through the femtocell base station 201F. Then, an ID response signal (Identity Response) is transmitted from the mobile phone 210X to the femtocell base station 201F. The ID response signal includes the IMSI of the mobile phone 210X.

Then, at step SP3, the determining unit 30 (see FIG. 23) determines whether the IMSI included in the received ID response signal matches the IMSI registered in the registering unit 31. Since the IMSI of the mobile phone 210X is already registered in the registering unit 31, the result of the determination made by the determining unit 30 is “OK”.

In this case, next, at step SP4, the ID response signal received from the mobile phone 210X is transmitted from the femtocell base station 201F to the mobile communication network 205.

Then, at step SP5, an authentication request signal (Authentication Request) is transmitted from the mobile communication network 205 to the mobile phone 210X through the femtocell base station 201F. In addition, an authentication response signal (Authentication Response) is transmitted from the mobile phone 210X to the mobile communication network 205 through the femtocell base station 201F.

Then, at step SP6, setting information (Security Mode Command) for setting security mode is transmitted from the mobile communication network 205 to the mobile phone 210X through the femtocell base station 201F. In addition, a security mode setting complete signal (Security Mode Complete) is transmitted from the mobile phone 210X to the mobile communication network 205 through the femtocell base station 201F.

Then, at step SP7, setting information (GUTI Reallocation Command) for reallocating a GUTI (Global Unique Temporary Identifier) is transmitted from the mobile communication network 205 (specifically, an EPC (Evolved Packet Core)) to the mobile phone 210X through the femtocell base station 201F. In addition, a GUTI reallocation complete signal (GUTI Reallocation Complete) is transmitted from the mobile phone 210X to the mobile communication network 205 through the femtocell base station 201F.

Then, at step SP8, a tracking area update accept signal (Tracking Area Update Accept) is transmitted from the mobile communication network 205 to the mobile phone 210X through the femtocell base station 201F. In addition, a tracking area update complete signal (Tracking Area Update Complete) is transmitted from the mobile phone 210X to the mobile communication network 205 through the femtocell base station 201F.

In the course of the processing up to step SP8, the femtocell base station 201F receives various signals from the mobile phone 210X. Hence, next, at step SP9, the radio wave arrival direction identifying unit 24 (see FIG. 23) identifies a direction of arrival of radio waves from the mobile phone 210X. In addition, the weight determining unit 32 determines a weight that allows a peak of a transmit beam from the antenna 202F to be steered in the direction of arrival of radio waves from the mobile phone 210X. Signals transmitted from the femtocell base station 201F to the mobile phone 210X during processes after the next cell search (see FIG. 26) are multiplied by this weight by the weight multiplying unit 33. That is, after controlling the directivity of the antenna 202F such that a peak of a transmit beam is steered towards the mobile phone 210X, the next and subsequent cell searches, random accesses, RRC connections, and UE-to-network connections are performed.

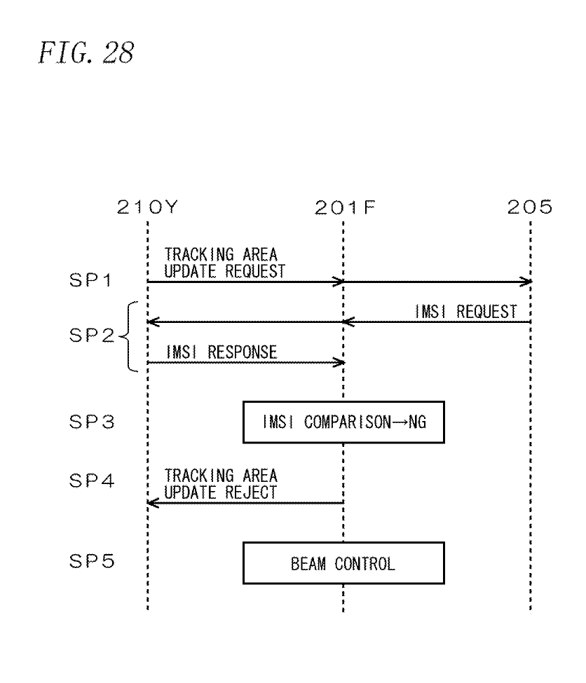

FIG. 28 is a diagram showing the flow of processes performed when there is a location registration request from the mobile phone 210Y which is an unregistered terminal. First, at step SP1, a tracking area update request signal (Tracking Area Update Request) is transmitted from the mobile phone 210Y to the mobile communication network 205 (specifically, the HLR) through the femtocell base station 201F.

Then, at step SP2, an ID request signal (Identity Request) for obtaining an IMSI is transmitted from the mobile communication network 205 to the mobile phone 210Y through the femtocell base station 201F. Then, an ID response signal (Identity Response) is transmitted from the mobile phone 210Y to the femtocell base station 201F. The ID response signal includes the IMSI of the mobile phone 210Y.

Then, at step SP3, the determining unit 30 (see FIG. 23) determines whether the IMSI included in the received ID response signal matches the IMSI registered in the registering unit 31. Since the IMSI of the mobile phone 210Y is not registered in the registering unit 31, the result of the determination made by the determining unit 30 is “NG”.

In this case, next, at step SP4, a tracking area update reject signal (Tracking Area Update Reject) is transmitted from the femtocell base station 201F to the mobile phone 210Y. Here, a reject cause (Reject Cause No. 15) indicating that the femtocell 203F is not an optimum cell is notified from the femtocell base station 201F to the mobile phone 210Y, whereby the mobile phone 210Y searches for an optimum cell other than the femtocell 203F. In the example of FIG. 22, since the mobile phone 210Y is located not only in the femtocell 203F but also in the macrocell 203M, the mobile phone 210Y camps on the macrocell 203M. Note that, for the tracking area update reject cause, a reject cause (Reject Cause No. 25) indicating that the mobile phone 210Y does not belong to a terminal group (CSG: Closed Subscriber Group) that is allowed to access the femtocell base station 201F may be notified from the femtocell base station 201F to the mobile phone 210Y.

In the course of the processing up to step SP4, the femtocell base station 201F receives various signals from the mobile phone 210Y. Hence, next, at step SP5, the radio wave arrival direction identifying unit 24 (see FIG. 23) identifies a direction of arrival of radio waves from the mobile phone 210Y. In addition, the weight determining unit 32 determines a weight that allows a null of a transmit beam from the antenna 202F to be steered in the direction of arrival of radio waves from the mobile phone 210Y. Signals transmitted from the femtocell base station 201F to the mobile phone 210Y during the next cell search (see FIG. 26) are multiplied by this weight by the weight multiplying unit 33. By steering a null, the mobile phone 210Y does not receive a synchronization channel or system information from the femtocell base station 201F.

Although the above description is made of processes performed when there is a tracking area update request (location registration request) from a mobile phone 210, when there is an attach request (Attach Request) from a mobile phone 210, too, the attach request can be processed in the same manner as above. In the attach request, the IMSI of the mobile phone 210X is registered in an MME (Mobility Management Entity) instead of in the HLR.

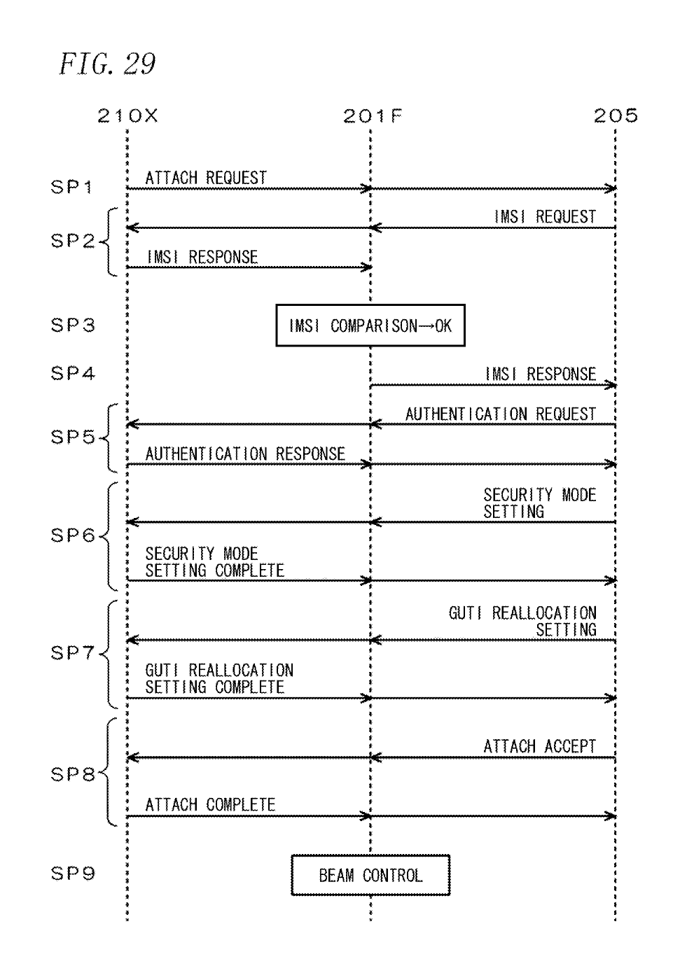

FIG. 29 is a diagram showing the flow of processes performed when there is an attach request from the mobile phone 210X which is a registered terminal. First, at step SP1, an attach request signal (Attach Request) is transmitted from the mobile phone 210X to the mobile communication network 205 (specifically, the MME) through the femtocell base station 201F.

Then, at step SP2, an ID request signal (Identity Request) for obtaining an IMSI is transmitted from the mobile communication network 205 to the mobile phone 210X through the femtocell base station 201F. Then, an ID response signal (Identity Response) is transmitted from the mobile phone 210X to the femtocell base station 201F. The ID response signal includes the IMSI of the mobile phone 210X.

Then, at step SP3, the determining unit 30 (see FIG. 23) determines whether the IMSI included in the received ID response signal matches the IMSI registered in the registering unit 31. Since the IMSI of the mobile phone 210X is already registered in the registering unit 31, the result of the determination made by the determining unit 30 is “OK”.

In this case, next, at step SP4, the ID response signal received from the mobile phone 210X is transmitted from the femtocell base station 201F to the mobile communication network 205.

Then, at step SP5, an authentication request signal (Authentication Request) is transmitted from the mobile communication network 205 to the mobile phone 210X through the femtocell base station 201F. In addition, an authentication response signal (Authentication Response) is transmitted from the mobile phone 210X to the mobile communication network 205 through the femtocell base station 201F.

Then, at step SP6, setting information (Security Mode Command) for setting security mode is transmitted from the mobile communication network 205 to the mobile phone 210X through the femtocell base station 201F. In addition, a security mode setting complete signal (Security Mode Complete) is transmitted from the mobile phone 210X to the mobile communication network 205 through the femtocell base station 201F.

Then, at step SP7, setting information (GUTI Reallocation Command) for reallocating a GUTI is transmitted from the mobile communication network 205 (specifically, the EPC (Evolved Packet Core)) to the mobile phone 210X through the femtocell base station 201F. In addition, a GUTI reallocation complete signal (GUTI Reallocation Complete) is transmitted from the mobile phone 210X to the mobile communication network 205 through the femtocell base station 201F.

Then, at step SP8, an attach accept signal (Attach Accept) is transmitted from the mobile communication network 205 to the mobile phone 210X through the femtocell base station 201F. In addition, an attach complete signal (Attach Complete) is transmitted from the mobile phone 210X to the mobile communication network 205 through the femtocell base station 201F.

In the course of the processing up to step SP8, the femtocell base station 201F receives various signals from the mobile phone 210X. Hence, next, at step SP9, the radio wave arrival direction identifying unit 24 (see FIG. 23) identifies a direction of arrival of radio waves from the mobile phone 210X. In addition, the weight determining unit 32 determines a weight that allows a peak of a transmit beam from the antenna 202F to be steered in the direction of arrival of radio waves from the mobile phone 210X. Signals transmitted from the femtocell base station 201F to the mobile phone 210X during processes after the next cell search (see FIG. 26) are multiplied by this weight by the weight multiplying unit 33. That is, after controlling the directivity of the antenna 202F such that a peak of a transmit beam is steered towards the mobile phone 210X, the next and subsequent cell searches, random accesses, RRC connections, and UE-to-network connections are performed.

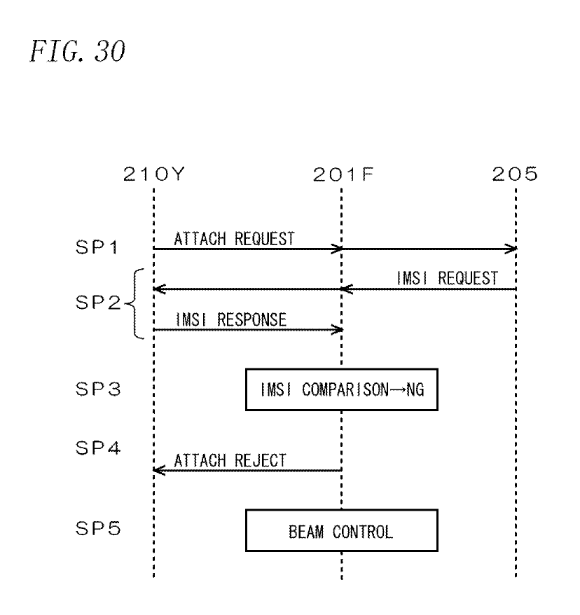

FIG. 30 is a diagram showing the flow of processes performed when there is an attach request from the mobile phone 210Y which is an unregistered terminal. First, at step SP1, an attach request signal is transmitted from the mobile phone 210Y to the mobile communication network 205 (specifically, the MME) through the femtocell base station 201F.

Then, at step SP2, an ID request signal for obtaining an IMSI is transmitted from the mobile communication network 205 to the mobile phone 210Y through the femtocell base station 201F. Then, an ID response signal is transmitted from the mobile phone 210Y to the femtocell base station 201F. The ID response signal includes the IMSI of the mobile phone 210Y.

Then, at step SP3, the determining unit 30 (see FIG. 23) determines whether the IMSI included in the received ID response signal matches the IMSI registered in the registering unit 31. Since the IMSI of the mobile phone 210Y is not registered in the registering unit 31, the result of the determination made by the determining unit 30 is “NG”.

In this case, next, at step SP4, an attach reject signal (Attach Reject) is transmitted from the femtocell base station 201F to the mobile phone 210Y. Here, a reject cause (Reject Cause No. 15) indicating that the femtocell 203F is not an optimum cell is notified from the femtocell base station 201F to the mobile phone 210Y, whereby the mobile phone 210Y searches for an optimum cell other than the femtocell 203F. In the example of FIG. 22, since the mobile phone 210Y is located not only in the femtocell 203F but also in the macrocell 203M, the mobile phone 210Y camps on the macrocell 203M. Note that, as with that described above, for the attach reject cause, a reject cause (Reject Cause No. 25) indicating that the mobile phone 210Y does not belong to a terminal group (CSG) that is allowed to access the femtocell base station 201F may be notified from the femtocell base station 201F to the mobile phone 210Y.

In the course of the processing up to step SP4, the femtocell base station 201F receives various signals from the mobile phone 210Y. Hence, next, at step SP5, the radio wave arrival direction identifying unit 24 (see FIG. 23) identifies a direction of arrival of radio waves from the mobile phone 210Y. In addition, the weight determining unit 32 determines a weight that allows a null of a transmit beam from the antenna 202F to be steered in the direction of arrival of radio waves from the mobile phone 210Y. Signals transmitted from the femtocell base station 201F to the mobile phone 210Y during the next cell search (see FIG. 26) are multiplied by this weight by the weight multiplying unit 33. By steering a null, the mobile phone 210Y does not receive a synchronization channel or system information from the femtocell base station 201F.

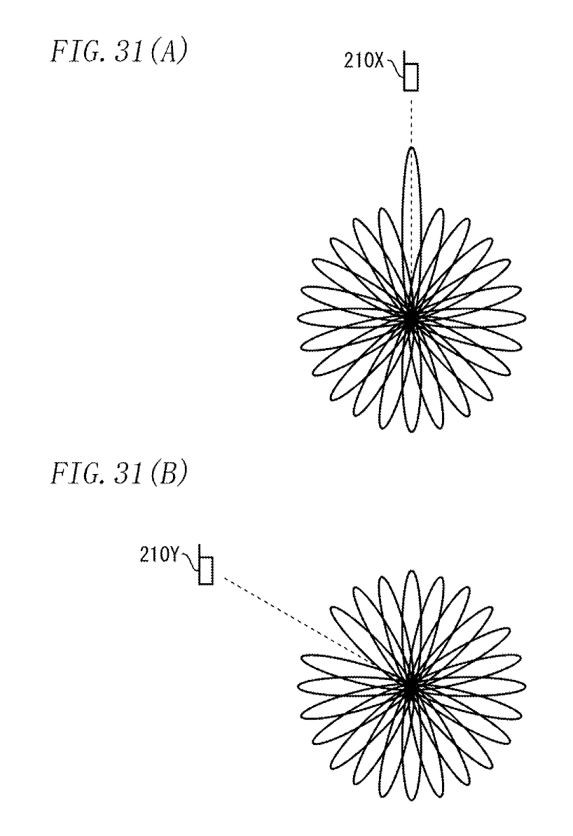

FIGS. 31A and 31B are schematic diagrams of superposition of transmit beams transmitted every certain period of time from the antenna 202F, the directivity of which is controlled by the beam control unit 25. The beam control unit 25 forms, by time division, transmit beams for the respective mobile phones 210X and 210Y. FIG. 31A shows transmit beams for the mobile phone 210X and FIG. 31B shows transmit beams for the mobile phone 210Y. As shown in FIG. 31A, a peak of a transmit beam is steered in a direction of arrival of radio waves from the mobile phone 210X which is a registered terminal. Note, however, that a peak (the highest value) does not necessarily need to be steered, and a beam with a higher intensity than beam intensities for directions different than the direction of arrival of radio waves from the mobile phone 210X (e.g., a reference intensity such as an average intensity) may be steered. As shown in FIG. 31B, a null of a transmit beam is steered in a direction of arrival of radio waves from the mobile phone 210Y which is an unregistered terminal. Note, however, that a null (the lowest value) does not necessarily need to be steered, and a beam with a lower intensity than beam intensities for directions different than the direction of arrival of radio waves from the mobile phone 210Y may be steered. Note that by transmitting a beam of the directional pattern shown in FIG. 31B at timing at which a synchronization channel is transmitted to the mobile phone 210Y from the femtocell base station 201F, the mobile phone 210Y does not receive a synchronization channel from the femtocell base station 201F.

According to the femtocell base station 201F according to the third embodiment, when the mobile phone 210Y accessing the femtocell base station 201F is determined by the determining unit 30 to be an unregistered terminal, the beam control unit 25 steers a null in a direction of arrival of radio waves from the mobile phone 210Y which is identified by the radio wave arrival direction identifying unit 24. By steering a null towards the mobile phone 210Y which is an unregistered terminal, the intensity of radio waves from the femtocell base station 201F to the mobile phone 210Y is weakened and thus the mobile phone 210Y cannot perform communication via the femtocell base station 201F. As a result, the mobile phone 210Y of a third person is avoided from being connected to the femtocell base station 201F, securing the number of mobile phones 210 accommodated, with which the femtocell base station 201F can perform simultaneous communications. Thus, an authorized user can reliably perform communication via the femtocell base station 201F.

In addition, according to the femtocell base station 201F according to the third embodiment, when the mobile phone 210X accessing the femtocell base station 201F is determined by the determining unit 30 to be a registered terminal, the beam control unit 25 steers a peak in a direction of arrival of radio waves from the mobile phone 210X which is identified by the radio wave arrival direction identifying unit 24. By steering a peak towards the mobile phone 210X which is a registered terminal, the intensity of radio waves from the femtocell base station 201F to the mobile phone 210X is strengthened. Thus, even when radio waves from the macrocell base station 201M reach, the mobile phone 210X can be reliably connected to the femtocell base station 201F but not to the macrocell base station 201M. As a result, an authorized user can surely obtain benefits (e.g., low rate communication service) brought about by communication via the femtocell base station 201F.

In addition, according to the femtocell base station 201F according to the third embodiment, by using an IMSI unique to each mobile phone 210 as unique identification information, the determining unit 30 can make an accurate determination between a registered terminal and an unregistered terminal. In addition, by the femtocell base station 201F requesting a mobile phone 210 for an IMSI, the determining unit 30 can perform a determination process using an IMSI sent as a response from the mobile phone 210.

In addition, according to the weight determining unit 32 shown in FIG. 24, weights by which outputs from the respective antenna elements 202FA and 202FB are multiplied are determined by computations performed by the computing unit 40. Thus, compared with the case of selecting optimum weights from among a plurality of patterns which are prepared in advance (FIG. 25), the accuracy of a beamforming direction can be improved.

In addition, according to the weight determining unit 32 shown in FIG. 25, since optimum weights are selected by the selecting unit 43 from among a plurality of patterns which are memorized in advance in the memory unit 42, the circuit size of arithmetic circuitry can be reduced.

Note that the user data extracting unit 23, the radio wave arrival direction identifying unit 24, and the weight determining unit 32 shown in FIG. 23 do not necessarily need to be mounted within the femtocell base station 201F, and may be mounted at any location within the communication system, as other apparatuses than the femtocell base station 201F.

Note also that the embodiments disclosed herein are to be considered in all respects as illustrative and not restrictive. The scope of the present invention is indicated by the appended claims rather than by the foregoing meaning, and all changes which come within the meaning and range of equivalency of the claims are therefore intended to be embraced therein.

### REFERENCE SIGNS LIST

101F: FEMTOCELL BASE STATION
103F: FEMTOCELL
100X and 110Y: MOBILE PHONE
130: PROCESSING UNIT
131: DETERMINING UNIT
132: REGISTERING UNIT
201F: FEMTOCELL BASE STATION
202F: ANTENNA
202FA and 202FB: ANTENNA ELEMENT
203F: FEMTOCELL
210X and 210Y: MOBILE PHONE
24: RADIO WAVE ARRIVAL DIRECTION IDENTIFYING UNIT
25: BEAM CONTROL UNIT
30: DETERMINING UNIT
31: REGISTERING UNIT
32: WEIGHT DETERMINING UNIT
33: WEIGHT MULTIPLYING UNIT
40: COMPUTING UNIT
42: MEMORY UNIT
43: SELECTING UNIT

1. A small-size base station that performs transmission and reception of radio waves with a mobile communication terminal located within its coverage area, the small-size base station comprising:
a registering unit that registers unique identification information of a mobile communication terminal that is allowed to access the small-size base station; and
a determining unit that determines whether unique identification information of a mobile communication terminal accessing the small-size base station is registered in the registering unit, and thereby determines whether the mobile communication terminal is a registered terminal or an unregistered terminal, wherein
access by an unregistered terminal to the small-size base station is limited based on a result of the determination made by the determining unit.

2. The small-size base station according to claim 1, further comprising a processing unit that processes, based on a registration request received from a mobile communication terminal, registration of information about the mobile communication terminal in a predetermined apparatus in a mobile communication network, wherein
when the mobile communication terminal having transmitted the registration request is determined by the determining unit to be a registered terminal, the processing unit performs a process for registering unique identification information of the mobile communication terminal in the predetermined apparatus, and
when the mobile communication terminal having transmitted the registration request is determined by the determining unit to be an unregistered terminal, the processing unit performs a process for not registering unique identification information of the mobile communication terminal in the predetermined apparatus.

3. The small-size base station according to claim 2, wherein when the mobile communication terminal having transmitted the registration request is determined by the determining unit to be an unregistered terminal, the processing unit transmits, as unique identification information of the mobile communication terminal, any predetermined value to the mobile communication network, in response to a unique identification information request transmitted from the mobile communication network to the mobile communication terminal, the any predetermine value being different than the unique identification information of the mobile communication terminal.

4. The small-size base station according to claim 2, wherein when the mobile communication terminal having transmitted the registration request is determined by the determining unit to be an unregistered terminal, the processing unit transmits, as an authentication response value from the mobile communication terminal, any predetermined value to the mobile communication network, in response to an authentication request transmitted from the mobile communication network to the mobile communication terminal, the any predetermined value being different than an authentication response value transmitted from the mobile communication terminal.

5. The small-size base station according to claim 2, wherein when the mobile communication terminal having transmitted the registration request is determined by the determining unit to be an unregistered terminal, a registration reject with a reject cause is transmitted from the small-size base station to the mobile communication terminal, the reject cause indicating that a cell of the small-size base station is not an optimum cell.

6. The small-size base station according to claim 2, wherein when the mobile communication terminal having transmitted the registration request is determined by the determining unit to be an unregistered terminal, a registration reject with a reject cause is transmitted from the small-size base station to the mobile communication terminal, the reject cause indicating that the mobile communication terminal does not belong to a terminal group that is allowed to access.

7. The small-size base station according to claim 2, wherein when unique identification information is included in the registration request received from the mobile communication terminal, the determining unit determines whether the mobile communication terminal is a registered terminal or an unregistered terminal, based on the unique identification information.

8. The small-size base station according to claim 1, wherein the unique identification information is an IMSI (International Mobile Subscriber Identity).

9. A communication control system comprising:
a mobile communication terminal; and
a small-size base station that performs transmission and reception of radio waves with a mobile communication terminal located within its coverage area, wherein
the small-size base station includes:
a registering unit that registers unique identification information of a mobile communication terminal that is allowed to access the small-size base station; and
a determining unit that determines whether unique identification information of a mobile communication terminal accessing the small-size base station is registered in the registering unit, and thereby determines whether the mobile communication terminal is a registered terminal or an unregistered terminal, and
access by an unregistered terminal to the small-size base station is limited based on a result of the determination made by the determining unit.

10. A small-size base station that performs transmission and reception of radio waves with a mobile communication terminal located within its coverage area, the small-size base station comprising:
an antenna;
a control unit that controls directivity of the antenna;
a registering unit that registers unique identification information of a mobile communication terminal that is allowed to access the small-size base station;
an identifying unit that identifies a direction of arrival of radio waves from a mobile communication terminal to the antenna; and
a determining unit that determines whether unique identification information of a mobile communication terminal accessing the small-size base station is registered in the registering unit, and thereby determines whether the mobile communication terminal is a registered terminal or an unregistered terminal, wherein
when the mobile communication terminal accessing the small-size base station is determined by the determining unit to be an unregistered terminal, the control unit steers a beam in a direction of arrival of radio waves from the mobile communication terminal identified by the identifying unit, the beam having a lower intensity than beam intensities for directions different than the direction of arrival of radio waves.

11. The small-size base station according to claim 10, wherein when the mobile communication terminal accessing the small-size base station is determined by the determining unit to be a registered terminal, the control unit steers a beam in a direction of arrival of radio waves from the mobile communication terminal identified by the identifying unit, the beam having a higher intensity than beam intensities for directions different than the direction of arrival of radio waves.

12. The small-size base station according to claim 10, wherein
the unique identification information is an IMSI (International Mobile Subscriber Identity), and
the small-size base station requests a mobile communication terminal accessing the small-size base station for an IMSI of the mobile communication terminal.

13. The small-size base station according to claim 10, wherein
the antenna has a plurality of antenna elements, and
the small-size base station further comprises a computing unit that computes weights by which outputs from the respective antenna elements are multiplied, based on a result of a determination made by the determining unit and a direction of arrival of radio waves identified by the identifying unit.

14. The small-size base station according to claim 10, wherein
the antenna has a plurality of antenna elements, and
the small-size base station further comprises:
a memory unit that memorizes a plurality of patterns regarding weights by which outputs from the respective antenna elements are multiplied; and
a selecting unit that selects weights by which outputs from the respective antenna elements are multiplied, from among the plurality of patterns based on a result of a determination made by the determining unit and a direction of arrival of radio waves identified by the identifying unit.

15. A communication control system comprising:
a mobile communication terminal; and
a small-size base station that performs transmission and reception of radio waves with a mobile communication terminal located within its coverage area, wherein
the small-size base station includes:
a control unit that controls directivity of an antenna of the small-size base station;
a registering unit that registers unique identification information of a mobile communication terminal that is allowed to access the small-size base station;
an identifying unit that identifies a direction of arrival of radio waves from a mobile communication terminal to the antenna; and
a determining unit that determines whether unique identification information of a mobile communication terminal accessing the small-size base station is registered in the registering unit, and thereby determines whether the mobile communication terminal is a registered terminal or an unregistered terminal, and
when the mobile communication terminal accessing the small-size base station is determined by the determining unit to be an unregistered terminal, the control unit steers a beam in a direction of arrival of radio waves from the mobile communication terminal identified by the identifying unit, the beam having a lower intensity than beam intensities for directions different than the direction of arrival of radio waves.

16. A communication control method of controlling communication by transmission and reception of radio waves between a small-size base station and a mobile communication terminal located within a coverage area of the small-size base station, comprising:
determining whether unique identification information of a mobile communication terminal accessing the small-size base station is registered in the small-size base station, and thereby determining whether the mobile communication terminal is a registered terminal or an unregistered terminal; and
limiting access by an unregistered terminal to the small-size base station based on a result of the latter determination.

17. A communication control method of controlling communication by transmission and reception of radio waves between a small-size base station and a mobile communication terminal located within a coverage area of the small-size base station, comprising:
identifying a direction of arrival of radio waves from a mobile communication terminal accessing the small-size base station to an antenna of the small-size base station;
determining whether unique identification information of a mobile communication terminal accessing the small-size base station is registered in the small-size base station, and thereby determining whether the mobile communication terminal is a registered tetininal or an unregistered terminal; and
controlling directivity of the antenna of the small-size base station in order to steer a beam in the identified direction of arrival of radio waves from the mobile communication terminal, when the mobile communication terminal is determined to be an unregistered terminal as a result of the determination, the beam having a lower intensity than beam intensities for directions different than the direction of arrival of radio waves.
